(19) United States
(12) Patent Application Publication
(10) Pub. No.: US 2026/0012967 A1
(43) Pub. Date: Jan. 8, 2026

(54) DEVICE-TO-DEVICE COMMUNICATION VIA A RADIO ACCESS NETWORK RELAY DEVICE

(71) Applicant: Fraunhofer-Gesellschaft zur Förderung der angewandten Forschung e.V., Muenchen (DE)

(72) Inventors: Thomas HAUSTEIN, Berlin (DE); Paul Simon Holt LEATHER, Berlin (DE)

(73) Assignee: Fraunhofer-Gesellschaft zur Förderung der angewandten Forschung e.V., Muenchen (DE)

(21) Appl. No.: 19/204,622

(22) Filed: May 12, 2025

Related U.S. Application Data
(63) Continuation of application No. PCT/EP2023/081467, filed on Nov. 10, 2023.

(30) Foreign Application Priority Data
Nov. 11, 2022 (EP) 22206927.0

(51) Int. Cl. H04W 72/40; H04B 7/185

(52) U.S. Cl. CPC H04W 72/40; H04B 7/1851

(57) ABSTRACT

A wireless communication network is described, which includes one or more relay devices and one or more user devices, UEs. A relay devices provides a first bidirectional link having first relay resources, and a second bidirectional link having second relay resources, the first and second bidirectional links using a first interface for a communication with a radio access network, RAN, of the wireless communication network, e.g., the Uu interface. A UE is to perform a direct communication with a network entity of the wireless communication network via the relay device on one or more the first relay resources or on one more of the first and second relay resources using a second interface for a device-to-device, D2D, or sidelink, SL, communication in the wireless communication network, e.g., the PC5 interface.

### CROSS-REFERENCES TO RELATED APPLICATIONS

This application is a continuation of copending International Application No. PCT/EP2023/081467, filed Nov. 10, 2023, which is incorporated herein by reference in its entirety, and additionally claims priority from European Application No. 22206927.0, filed Nov. 11, 2022, which is also incorporated herein by reference in its entirety.

### TECHNICAL FIELD

The present invention refers to wireless communication systems or networks, more specifically to wireless communication networks including a relay device, like a radio access network, RAN, relay device, providing respective bidirectional links to the RAN of the wireless communication system. Embodiments of the present invention concern a wireless communication network, in which a user device may perform a direct communication to a network entity, like a RAN entity or another UE, via the relay device on one or more resources allocated for a communication on the bidirectional links.

### BACKGROUND OF THE INVENTION

FIG. 1A and FIG. 1B are a schematic representation of an example of a wireless network 100 including, as is shown in FIG. 1A, the core network 102 and one or more radio access networks RAN₁, RAN₂, . . . . RAN_{N}. FIG. 1B is a schematic representation of an example of a radio access network RANₙ that may include one or more base stations gNB₁ to gNB₅, each serving a specific area surrounding the base station schematically represented by respective cells 1061 to 1065. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure.

FIG. 1B shows an exemplary view of five cells, however, the RANₙ may include more or less such cells, and RANₙ may also include only one base station. FIG. 1B shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1B shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UEs as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1B by the arrows pointing to “core”. The core network 102 may be connected to one or more external networks. The external network may be the Internet, or a private network, such as an Intranet or any other type of campus networks, e.g. a private Wi-Fi or 4G or 5G mobile communication system. Further, some or all of the respective base station gNB₁ to gNB₅ may be connected, e.g. via the S1 or X2 interface or the Xn interface in NR, with each other via respective backhaul links 116₁ to 116₅, which are schematically represented in FIG. 1B by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more of a system information block, SIB, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. Note, the sidelink interface may a support 2-stage SCI. This refers to a first control region containing some parts of the SCI, and optionally, a second control region, which contains a second part of control information.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix, CP, length. A frame may also consist of a smaller number of OFDM symbols, e.g. when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other IFFT-based signal with or without CP, e.g. DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., using the LTE-Advanced pro standard, or the 5G or NR, New Radio, standard, or the NR-U, New Radio Unlicensed, standard.

The wireless network or communication system depicted in FIG. 1A and FIG. 1B may be a heterogeneous network having distinct overlaid networks, e.g., a network of macro cells with each macro cell including a macro base station, like base station gNB₁ to gNB₅, and a network of small cell base stations, not shown in FIG. 1A and FIG. 1B, like femto or pico base stations. FIG. 2 is a block diagram of a wireless communication network including, as has been described above with reference to FIG. 1A and FIG. 1B, a RAN entity, like a base station 120, which serves one or more UEs 122₁, 122₂. The base station 120 provides for a communication between one or more of the UEs 122₁, 122₂ and another network entity 126, e.g., another UE served by the base station 120, or a further base station of the network, or an application server coupled to the network entity 126. The base station 120 communicates with the network entity 126 via a relay device 128 so that, for example, the coverage of the base station 120, i.e., the area within which the base station may serve other user devices, is extended by using the relay device 128. In accordance with other examples, the relay device 128 may be employed so as to overcome obstacles impeding the range of the base station, for example in case the base station is located in an area surrounded by mountains the coverage may not extend to a neighboring valley, and by means of the relay device 128 the coverage of the base station in one valley may be extended to a neighboring valley. Likewise, an indoor scenario may be envisaged in which the UE is connected to a base station, like a small cell base station within a building, and by means of the relay device the small cell base station may be connected to a macro base station located outside the building. In accordance with yet other examples, the relay device 120 may also be a spaceborne or airborne device, like a satellite or an airplane, for example for connecting the base station in a remote area to the core network of the wireless communication system. A first bidirectional link 134, also referred to as the access or service link, is established between the relay device 128 and the base station, and a second bidirectional link 136, also referred to as the backhaul or feeder link, is established between the relay device 128 and the network entity 126. A communication over the links 134, 136 uses the Uu interface. Further, respective bidirectional links 1381, 1382 using the Uu interface are established between the base station 120 and the UEs 122₁, 122₂. Since the relay device 128 provides the respective bidirectional links 134, 136 to the RAN of the wireless communication system, the relay device may also be referred to as a RAN relay device.

The above described relay device 128 may operate using with the so called bent pipe or u-bend principle, sending back to what goes into the conduit with only amplification and possibly a shift from uplink to downlink frequencies. Payload transmitted using this principle is also referred to as bent pipe payload or transparent payload. In accordance with other examples, a relay device 128 may use on-board processing so that the signal is demodulated, decoded, re-encoded and modulated by the relay device. Payload transmitted using this principle is also referred to as regenerative payload.

As mentioned above, the relay device or repeater 128 may be a spaceborne device or an airborne device so that the above described wireless communication network may also include non-terrestrial network, NTN, components. Spaceborne devices may include satellites at different altitudes or orbital periods, like a low earth orbit, LEO, a medium earth orbit, MEO, a geosynchronous orbit, GSO, a geostationary orbit, GEO, or a high earth orbit, HEO, whereas airborne vehicles may include unmanned aircraft systems, UAS, such as a tethered UAS, a lighter than air, LTA, UAS, a heavier than air, HTA, UAS, and a high altitude UAS platform, HAP. FIG. 3 is a schematic representation of an example of the wireless communication network of FIG. 2 including, as also described with reference to FIG. 1A-B, the core network 102 and the RAN, which includes the base station 120 serving the UE 122₁ and one or more further base stations 130₁, 130₂. The relay device connecting the base station 120 to the one or more further base stations 130₁, 130₂ is a satellite 128a or an air plane 128b. The base stations 120, 130₁, 130₂ are connected to the satellite 128a and to the air plane 128b via respective gateways 132₁ to 132₃. Thus, the example of FIG. 3 illustrates a wireless communication network including several NTN components, which include the one or more spaceborne/airborne devices 128a, 128b and the respective NTN gateways, NTN GWs, 132₁ to 132₃. The arrows 134₁ and 134₂ schematically represent uplink/downlink connections for communicating data between the base station 120, via the NTN GW 132₃, and the respective spaceborne/airborne devices 128a, 128b, also referred to as service links. The spaceborne/airborne devices 128a, 128b are connected to the core network 102 via the NTN GWs 132₁, 132₂ and the base stations 130₁, 130₂, via respective links 136₁, 136₂, also referred to as feeder links. The uplink/downlink connections between the base station 120 and the UE 122₁ are schematically represented by the arrow 138.

It is noted that the information in the above section is only for enhancing the understanding of the background of the invention and therefore it may contain information that does not form the conventional technology that is already known to a person of ordinary skill in the art.

In a wireless communication network as described above, there may be a need for improvements in the communication between a user device and a destination entity via a base station connected to the destination via a relay device.

### SUMMARY

According to an embodiment, a wireless communication network may have: one or more relay devices, wherein a relay devices provides a first bidirectional link having first relay resources, and a second bidirectional link having second relay resources, the first and second bidirectional links using a first interface for a communication with a radio access network, RAN, of the wireless communication network, e.g., the Uu interface, and one or more user devices, UEs, wherein a UE is to perform a direct communication with a network entity of the wireless communication network via the relay device on one or more the first relay resources or on one more of the first and second relay resources using a second interface for a device-to-device, D2D, or sidelink, SL, communication in the wireless communication network, e.g., the PC5 interface.

Another embodiment may have a user device, UE, for a wireless communication network having one or more relay devices, wherein a relay devices provides a first bidirectional link having first relay resources, and a second bidirectional link having second relay resources, the first and second bidirectional links using a first interface for a communication with a radio access network, RAN, of the wireless communication network, e.g., the Uu interface, wherein the UE is to perform a direct communication with a network entity of the wireless communication network via the relay device on one or more the first relay resources or on one more of the first and second relay resources using a second interface for a device-to-device, D2D, or sidelink, SL, communication in the wireless communication network, e.g., the PC5 interface.

According to another embodiment, a method for operating a wireless communication network, having one or more relay devices, wherein a relay devices provides a first bidirectional link having first relay resources, and a second bidirectional link having second relay resources, the first and second bidirectional links using a first interface for a communication with a radio access network, RAN, of the wireless communication network, e.g., the Uu interface, may have the step of: performing by one or more user devices, UEs, a direct communication with a network entity of the wireless communication network via the relay device on one or more the first relay resources or on one more of the first and second relay resources using a second interface for a device-to-device, D2D, or sidelink, SL, communication in the wireless communication network, e.g., the PC5 interface.

Another embodiment may have a non-transitory digital storage medium having stored thereon a computer program product for performing the above method for operating a wireless communication network when the computer program is run by a computer.

### BRIEF DESCRIPTION OF THE DRAWINGS

Embodiments of the present invention are now described in further detail with reference to the accompanying drawings, in which:

FIG. 1A and FIG. 1B show a schematic representation of an example of a terrestrial wireless communication network;

FIG. 2 is a schematic representation of an example of a wireless communication network connecting a base station to a destination via a relay device;

FIG. 3 is a schematic representation of an example of the wireless communication network of FIG. 2 in which the relay device is a satellite or an air plane;

FIG. 4 illustrates a wireless communication network, like a third generation partnership project, 3GPP, network in accordance with an embodiment of the present invention;

FIG. 5 illustrates a wireless communication system in accordance with embodiments of the present invention using as the relay device a satellite;

FIG. 6 illustrates a further embodiment of the present invention according to which the UE acts as a relay UE for a remote UE;

FIG. 7 illustrates an embodiment of a chained connection of satellites to reach a destination which is connected to the core network of the wireless communication system;

FIG. 8 depicts an embodiment, wherein a UE is connected via a 5G-NR NTN using the Uu interface over a satellite to a NTN base station (ground station);

FIG. 9 depicts an embodiment of a communication system, wherein two UEs are out of coverage from a terrestrial network but within the coverage footprint of a satellite and communicate over the sidelink via the satellite;

FIG. 10 depicts an embodiment of a communication system as in FIG. 9 with the satellite not connected to the network;

FIG. 11 depicts an embodiment of a communication system as in FIG. 9 or in FIG. 10 with the UEs being not inter-connectable via NTN Uu;

FIG. 12A to FIG. 12E illustrate embodiments of the sub-structuring of the FDD bands or subbands to be used for establishing a sidelink communication via the relay device;

FIG. 13A to FIG. 13C illustrate an embodiment in which an allocated paired spectrum for an FDD operation of a satellite communication system is used for sidelink communication dependent on whether a link to the ground station has been lost;

FIG. 14 illustrates an example for using resources in the uplink/downlink bands for a sidelink communication;

FIG. 15 shows a schematic block diagram of a UE according to an embodiment of the present invention;

FIG. 16 shows a schematic block diagram of a UE according to a further embodiment of the present invention; and

FIG. 17 illustrates an example of a computer system on which units or modules as well as the steps of the methods described in accordance with the inventive approach may execute.

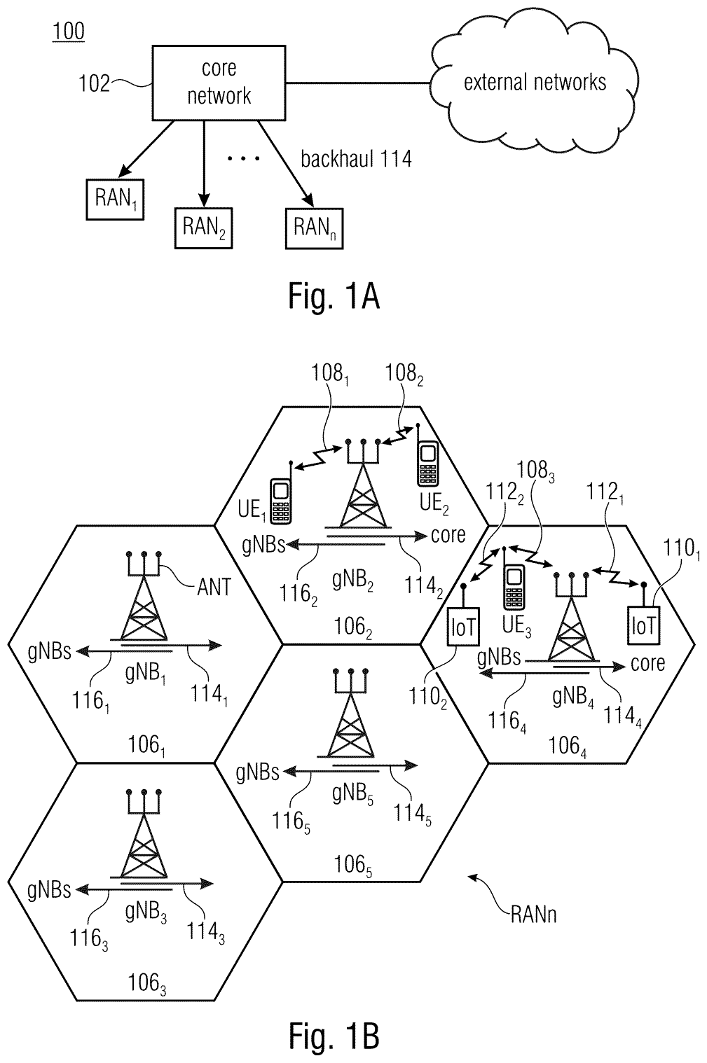

### DETAILED DESCRIPTION OF THE INVENTION

Embodiments of the present invention are now described in more detail with reference to the accompanying drawings in which the same or similar elements have the same reference signs assigned.

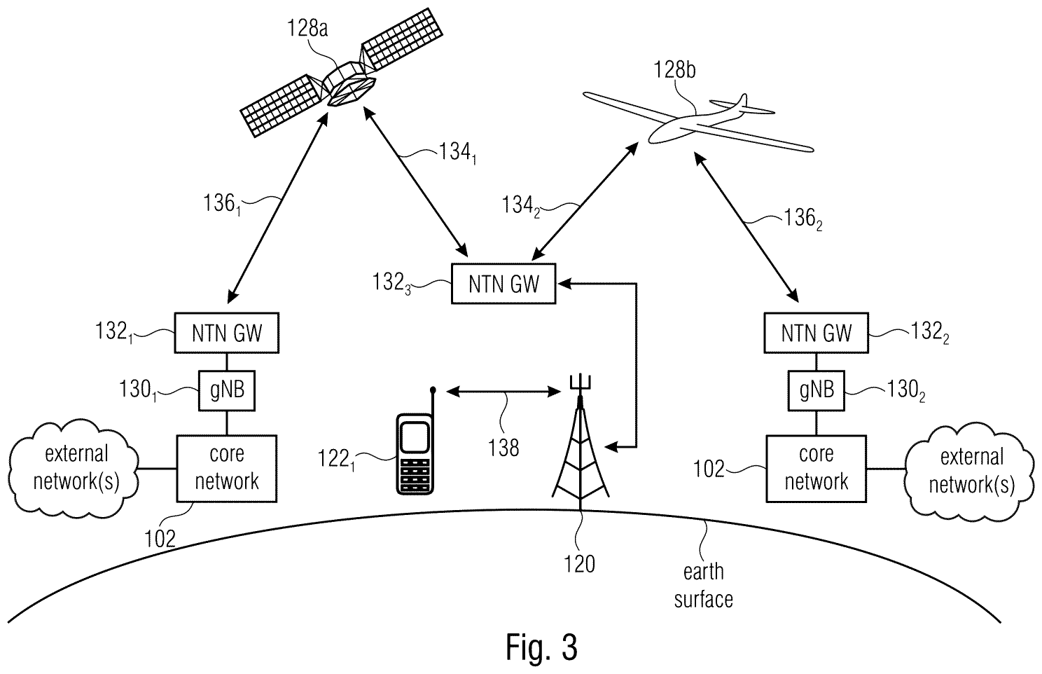

When considering a wireless communication scenario employing a wireless communication network as described above with reference to FIG. 3, UE 122₁ may wish to establish a communication with a third party that may be connected to the gNB 130₁, like another UE, or located in an external network connected to the core network 102. In such a scenario, UE 122₁ communicates over the uplink/downlink 138 with the base station 122 which, in turn, via the NTN GW 132₃ and the satellite 128a and the NTN GW 132₁ connects to the gNB 130₁ which provides for the connection to the desired network entity, like another UE connected to the gNB 130₁ via the Uu interface, or a core network entity, or an external device connected to the core network 102. However, a communication between the UE 122₁ and the base station 120, i.e., a communication via the terrestrial radio access network RAN, may not be possible or feasible. For example, due to a lack of service coverage a connection between to UE 122₁ and the base station 120 may be lost or not established, e.g., because UE 122₁ is located in a remote location so that the link 138 to the base statin 120 is lost or may not be established. Due to a service outage a communication may not be feasible, e.g., because the base station 120 is not operative which may be due to a natural disaster, a power outage or the like. Further, a communication may not be considered feasible, despite an stablished connection to the desired destination or network entity, e.g., because certain requirements associated with the communication may not be met, like a desired quality of service, QoS, associated with the. This may be due to the latency of the communication between the UE 122₁ and the network entity being insufficient or unacceptable for the desired QoS, or because a bandwidth or capacity or data rate of the backhaul connection, i.e., the connection from the base station 120 via the NTN GW 132₃, the satellite 128a, the NTN GW 132₁, the gNB 130₁, is insufficient or unacceptable for the desired QoS, or because an end-to-end reliability of the communication is insufficient or unacceptable for the desired QoS.

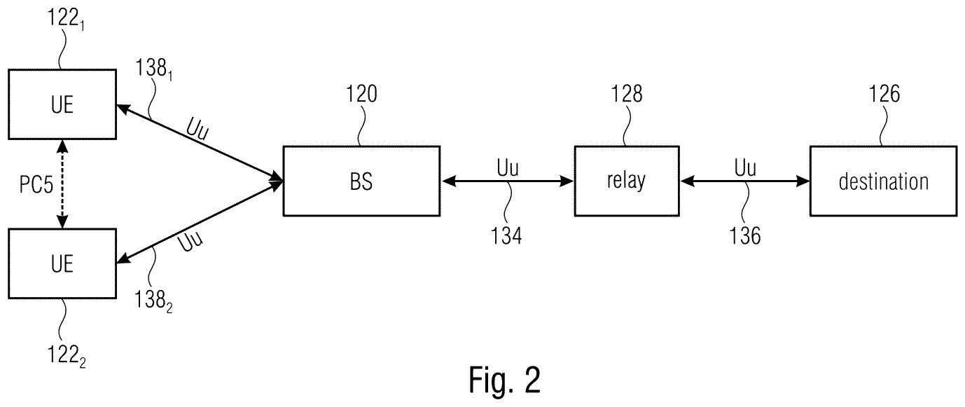

In other words, in a scenario as described above with reference to FIGS. 2 and 3 in which a base station communicates with a desired destination or network entity of a communication from a user device via a relay device connected between the destination and the base station, despite the advantages achieved by the relay device, a communication from the user device towards the destination may not be possible at all, for example because a connection between the user device and the base station and/or a connection between the base station and the relay device is lost or may not be established, or because a communication has associated therewith a certain requirement, like a certain QoS, that may not be met by the channel established between the UE and the destination over the base station and the relay device.

In accordance with another scenario, UE 122₁ and a further UE within the coverage of the base station 120 may communicate directly with each other over a sidelink using the PC5 interface. In case the sidelink connection may not be established or is lost, UE 122₁ and the further UE need to establish a connection via the base station 120 using the Uu interface. However, as mentioned above, such a connection via the base station 120 may not be possible at all, e.g., because one of the UEs is not within the coverage of the base station 120 or is not served by the base station 120. Also, it may not be possible to achieve a required quality of the communication over the Uu interface. In such a case no communication between the UEs is possible.

Embodiments of the present invention address the above problems and provide improvements in the communication between a user device and a destination or network entity in a system using a relay device providing respective bidirectional links to a radio access network of the wireless communication network.

### Wireless Communication Network

The present invention provides a wireless communication network, comprising:
one or more relay devices, wherein a relay devices provides a first bidirectional link comprising first relay resources, and a second bidirectional link comprising second relay resources, the first and second bidirectional links using a first interface for a communication with a radio access network, RAN, of the wireless communication network, e.g., the Uu interface, and
one or more user devices, UEs, wherein a UE is to perform a direct communication with a network entity of the wireless communication network via the relay device on one or more the first relay resources or on one more of the first and second relay resources using a second interface for a device-to-device, D2D, or sidelink, SL, communication in the wireless communication network, e.g., the PC5 interface.

In accordance with embodiments,
the network entity comprises a RAN entity, like a base station,
the UE is to perform a communication with the relay device on the first relay resources using the second interface, and
the relay device is to perform a communication with the RAN entity on the second relay resources using the first or second interface.

In accordance with embodiments, the UE is to perform the communication with the relay device on the first relay resources using the second interface responsive to one or more of the following:
a loss of connection between the UE and the RAN,
a connection between the UE and the RAN cannot be established,
a connection via the RAN cannot provide one or more required communication requirements, such as a desired Quality of Service, QoS, e.g., a latency, a bandwidth or capacity or data rate of a backhaul connection, or an end-to-end reliability may be not sufficient for obtaining the desired QoS,
a signaling indicting one or more operational modes related to a different use of the first and/or second resources and the first interface compared to a currently or previously used operational mode.

In accordance with embodiments,
the a network entity comprises a further UE,
the UE is to perform a communication with the relay device on the first relay resources using the second interface, and
the relay device is to perform a communication with the further UE on the second relay resources the first or second interface.

In accordance with embodiments, the wireless communication network comprises
a RAN entity, like a base station, and
a further relay device providing a third bidirectional link between the further UE and the further relay station and comprising third relay resources, and a fourth bidirectional link between the further relay station and the RAN entity and comprising fourth relay resources, the third and fourth bidirectional links using the first interface,
wherein
the further UE is to perform a communication with the further relay device on the third relay resources using the first or second interface, and
the further relay device is to perform a communication with the RAN entity on the fourth relay resources using the first or second interface.

In accordance with embodiments, the UE is to perform the communication with the further UE on the first and second relay resources using the first second interface responsive to one or more of the following:
a loss of connection between the UE and the RAN,
a connection between the UE and the RAN cannot be established,
a connection via the RAN cannot provide one or more required communication requirements, such as a desired Quality of Service, QoS, e.g., a latency, a bandwidth or capacity or data rate of a backhaul connection, or an end-to-end reliability may be not sufficient for obtaining the desired QoS,
a loss of connection between the relay device and the RAN,
a connection between the relay device and the RAN cannot be established,
a connection via the relay device cannot provide one or more required communication requirements, such as a desired Quality of Service, QoS, e.g., a latency, a bandwidth or capacity or data rate of a backhaul connection, or an end-to-end reliability may be not sufficient for obtaining the desired QoS,
a loss of sidelink connection between the UE and the further UE, the sidelink connection being performed on sidelink resources of the wireless communication network, the sidelink resources being different from the first and second relay resources,
a connection sidelink between the UE and the further UE cannot be established,
a sidelink between the UE and the further UE cannot provide one or more required communication requirements, such as a desired Quality of Service, QoS, e.g., a latency, a bandwidth or capacity or data rate of a backhaul connection, or an end-to-end reliability may be not sufficient for obtaining the desired QoS,
a signaling indicting one or more operational modes related to a different use of the first and/or second resources and the first interface compared to a currently or previously used operational mode.

In accordance with embodiments, the wireless communication network comprises a base station serving the UE and providing for an indirect communication between the UE and the network entity via the relay device, wherein, if a connection between the UE and the network entity is established, the UE is to
perform only the direct communication with the network entity, or
perform the direct communication with the network entity in addition to the indirect communication with the network entity.

In accordance with embodiments, the UE is aware of an availability or an expected availability of the relay device, and is to send a messaging information via an uplink sidelink broadcast, SL-BC, to the relay device on the first relay resources.

In accordance with embodiments, responsive to receiving the uplink SL-BC, the relay device is to forward the messaging information received in the uplink SL-BC towards at least the network entity via a downlink SL-BC.

In accordance with embodiments, responsive to receiving the downlink SL-BC, the network entity is to send a response message to the UE.

In accordance with embodiments,
the network entity is to send the response via a further uplink sidelink broadcast, SL-BC, to the relay device on the first or second relay resources,
responsive to receiving the further uplink SL-BC, the relay device is to forward the response message received in the further uplink SL-BC towards to the UE entity via a further downlink SL-BC on the first relay resources.

In accordance with embodiments, the wireless communication network comprises a remote UE, wherein the UE and the remote UE are directly connected with each other, and the UE is to relay a communication between the remote UE and the network entity.

In accordance with embodiments, the UE has a plurality of RAT capabilities, the plurality of RAT capabilities comprising
a first RAT capability for providing a SL connection with the remote UE using sidelink resources of the wireless communication network, the sidelink resources being different from the first and second relay resources, and the UE is to relay a communication to/from the remote UE, and
a second RAT capability for connecting the remote UE and the UE, e.g., Wi-Fi or Bluetooth.

In accordance with embodiments, the UE is subscribed, in addition to the wireless communication network, to one or more further networks, and wherein the UE and the remote UE are connected via
the wireless communication network providing a SL connection between the UE and the remote UE using sidelink resources of the wireless communication network, the sidelink resources being different from the first and second relay resources, and the UE is to relay a communication to/from the remote UE, and/or
one or more of the further networks, e.g., Wi-Fi or Bluetooth.

In accordance with embodiments, the relay device
includes at least a subset of base station functionality, like scheduling of resources, resource allocation or mapping, etc., or
is to operate as an amplify and forward, AF, relay, like an inband relay or an inband repeater, or
is to operate as an amplify, band switch and forward, ABSF, relay, like an outband relay or an outband repeater, or
is to operate as a decode-and-forward, DF, relay.

In accordance with embodiments, the sidelink communication comprises a Time Division Duplex, TDD, communication, or a Frequency Division Duplex, FDD, communication, or a or Full Duplex, FD, communication.

In accordance with embodiments, the first and second relay resources to be used by the UE for communicating with the network entity comprise unused or substantially unused radio resources allocated for a communication using the first interface.

In accordance with embodiments, the unused or substantially unused relay resources comprise radio resources including an amount of incumbent traffic not exceeding a predefined threshold, or being free of any incumbent traffic.

In accordance with embodiments, incumbent traffic comprises at least one of:
UL and/or DL traffic using the first interface from/to one or more other network entities on the first bidirectional of the relay device,
UL and/or DL traffic using the first interface from/to one or more other network entities on the second bidirectional of the relay device.

In accordance with embodiments, the first relay resources and/or second relay resources are allocated according to a FDD configuration paired spectrum, the FDD configuration paired spectrum defining a first or downlink, DL, frequency band for transmissions by the relay device and a second or uplink, UL, frequency band to transmissions to the relay device.

In accordance with embodiments,
the DL frequency band and/or the UL frequency band is subdivided in
one or more first UL slots for transmissions from the BS to the relay device, and one or more second UL slots for transmissions from the UE to the relay device, and/or
one or more first band width parts, BWPs, for transmissions from the BS to the relay device, and one or more second BWPs for transmissions from the UE to the relay device, and
in case the DL frequency band or the UL frequency band is not subdivided, it is used completely for transmissions to/from the relay device.

In accordance with embodiments, the UE is to synchronize the communication with the relay device on the DL frequency band and/or the UL frequency band using one or more reference signals broadcast in the DL frequency band and/or UL frequency band, wherein the one or more reference signals may come from the relay device, like a beacon signal, or another network device operating in the respective band.

In accordance with embodiments, the relay device is to transmit in the DL frequency band a DL control channel, the DL control channel including additional information with respect to radio resources which are temporarily or semi-statically provided for the direct or sidelink communication between the UE and the relay device, e.g., a Block Waiting Time, BWT, a number of slots, a number of resource Blocks, RBs, etc.

In accordance with embodiments, the UE is to obtain a configuration for performing the communication with the network entity using one or more of the following:
a pre-set or preconfigured configuration, e.g., a default configuration, a configuration according to factory settings, a recently updated configuration, based on a last used configuration or a last used mode of operation or a change in a mode of operation, e.g. from a Uu link to a sidelink, from a sidelink to a Uu link, from a Uu link to a relay link, from a relay link to a Uu link, from a SL to a relay link or from a relay link to a SL),
a configuration provided by the network,
a configuration provided by a database, e.g., a database connected to the RAN as an entity,
a configuration provided via an alternative RAN, e.g., via Wi-Fi or Bluetooth,
a configuration provided by a remote UE or a group leader UE,
a configuration provided by a sidelink connection either:
   directly from a further UE connected over the SL with the UE, or
   indirectly from a further UE connected over the SL and via the relay device with the UE.

In accordance with embodiments, the UE is to receive from the network entity one or more assistance information messages, AIMs,
wherein the one or more AIMs may include one or more of the following:
   resource allocation related assistance information, like
   resource patters
   resource pools
   available and/or excluded radio resources
   information about particular frame structures, e.g., (pseudo)-TDD slot structures on FDD bands, sub-band full duplex, SBFD, configurations, almost blank subframes, ABS, in one or more FDD or TDD bands to be used for SL-communication
   a sub-band full duplex, SBFB, configuration indication
link related assistance information, like
   temporal (current and future), availability/unavailability, readiness of connectivity opportunities (e.g. windows of opportunity to see a satellite or satellite constellation areas), shortage or plentifulness of resources
timing advance assistance information
Doppler assistance information
distance related assistance information,
geographical area related assistance information,
group related assistance information,
UE pair related assistance information,
relay/repeater related assistance information,
capability information of a device transmitting or receiving the AIM,
requested information by the device transmitting or receiving the AIM about capability information to be provided by the UE,
a distress message header with wakeup, configuration state activation trigger function or priority purpose (e.g. transmitting an emergency message containing distress ID, requested action, location, UE-ID etc.).

In accordance with embodiments, the relay resources and the additional relay resources comprise one or more of the following:
one or more symbols,
one or more time slots or subframes or frames,
one or more frequencies or carriers or subchannels or group of subchannels,
one or more subcarriers, e.g., for transmission of IoT messages like NB-IoT, LoRA etc.
one or more interfaces
one or more channels e.g., a control channel, a user data channel or any other channel for a dedicated purpose,
one or more resource block sets, RB sets,
one or more frequency bands, like unlicensed subbands,
one or more bandwidth parts,
one or more resource pools,
one or more LBT sub-bands,
one or more spatial resources, e.g., using spatial multiplexing, directional beams etc.

In accordance with embodiments, the set of relay resources and the set of additional relay resources comprise one or more of the following:
one or more than one resource,
a channel,
a sub-channel,
a sub-band,
an RB set,
an interface,
a resource pool,
a Bandwidth Part, BWP.

In accordance with embodiments, the network entity comprises one or more of the following:
a further BS,
a roadside unit, RSU,
an orbital side unit, OSU, the orbital side unit exchanging information with passing satellites or airplanes,
a mobile BS mounted on a land or water vehicle, e.g., a car, a bus, a train, a ship or vessel, a submarine, or mounted on a container or on any piece of equipment mounted on or attached to the vehicle,
a mobile BS mounted on a non-terrestrial or air-borne vehicle or device, e.g., an aircraft, a UAV, a balloon, a rocket, a satellite or any other object or device moving or floating in 3D-space without being in touch with the surface of a planet or a liquid on the planet, e.g. water of a lake or the sea,
a further UE,
a Customer Premises Equipment, CPE
an IoT device,
a broadcast tower like one used for digital audio (radio) or Television (video) broadcast,
a relay device,
a further relay device,
a core network,
a function located somewhere in the communication network, e.g., a UPF, LMF, AMF, SMF etc.,
an application server connected to the core network,
an aggregation node for, e.g., storage, processing (fusion, decision making, computing outputs) or forwarding of sensor data, messages, retransmissions, AIM, measurements reports, configurations etc.,
a data base.

In accordance with embodiments, the relay device comprises one or more of the following:
a moving or stationary ground-borne device, like a relay, a repeater, a vehicle mounted relay or repeater, or a reconfigurable reflected surface, RIS,
a moving or stationary liquid-borne device, e.g., on or in water such as a ship or a submarine, like a relay, a repeater, a vehicle mounted relay or repeater, or a reconfigurable reflected surface, RIS,
a moving or stationary air-borne device, like a drone, an unmanned aerial vehicle, UAV, or an airplane,
a moving or stationary space-borne device, like a low earth orbit, LEO, satellite, a medium earth orbit, MEO, satellite, or a geosynchronous earth orbit, GEO, satellite.

In accordance with embodiments,
the first interface comprises an Uu air interface for a connection with the RAN, and
the second interface comprises a PC5 interface for a D2D or SL connection.

In accordance with embodiments, the UE and/or the relay device are to signal capability information.

In accordance with embodiments, the first bidirectional link comprises an access link or service link, and the second bidirectional link comprises a backhaul link or feeder link.

In accordance with embodiments,
the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or a water vehicle (ship, submarine), or road side unit, RSU, or a building, or a customer premises equipment CPE, or any other item or device provided with network connectivity enabling the item/device to communicate using the wireless communication network, e.g., a sensor or actuator, or any other item or device provided with network connectivity enabling the item/device to communicate using a sidelink, e.g., a sensor or actuator, or any sidelink capable network entity, and
the base station comprises one or more of a macro cell base station, or a small cell base station, or a central unit of a base station, or a distributed unit of a base station, or an Integrated Access and Backhaul, IAB, node, or a road side unit, RSU, or a UE, or a SL UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

In accordance with embodiments, the wireless communication network comprises
a 3^{rd} Generation Partnership Project, 3GPP, network, or
a Low Power Wide Area network, LPWAN, like a LoRA, network or moiety network, or
a Wi-Fi network.

### User Device

The present invention provides a user device, UE, for a wireless communication network comprising one or more relay devices, wherein a relay devices provides a first bidirectional link comprising first relay resources, and a second bidirectional link comprising second relay resources, the first and second bidirectional links using a first interface for a communication with a radio access network, RAN, of the wireless communication network, e.g., the Uu interface,
wherein the UE is to perform a direct communication with a network entity of the wireless communication network via the relay device on one or more the first relay resources or on one more of the first and second relay resources using a second interface for a device-to-device, D2D, or sidelink, SL, communication in the wireless communication network, e.g., the PC5 interface.

### Method

The present invention provides a method for operating a wireless communication network, comprising one or more relay devices, wherein a relay devices provides a first bidirectional link comprising first relay resources, and a second bidirectional link comprising second relay resources, the first and second bidirectional links using a first interface for a communication with a radio access network, RAN, of the wireless communication network, e.g., the Uu interface, the method comprising:
performing by one or more user devices, UEs, a direct communication with a network entity of the wireless communication network via the relay device on one or more the first relay resources or on one more of the first and second relay resources using a second interface for a device-to-device, D2D, or sidelink, SL, communication in the wireless communication network, e.g., the PC5 interface.

### Computer Program Product

Embodiments provide a computer program product comprising instructions which, when the program is executed by a computer, causes the computer to carry out one or more methods in accordance with the present invention.

Thus, embodiments of the present invention address the above described problems associated with the situation in which a UE operating in a wireless communication network as described above with reference to FIG. 2 is not able to communicate with the RAN at all or is not able to perform a communication in accordance with respective requirements thereof, like respective QoS requirements, by allowing the user device to directly connect to the destination or network entity via the relay device, like the satellite, thereby providing an opportunity to connect via the relay device in a single-hop wireless transmission to the destination entity. Conventionally, the relay device lacks any underlying network protocols for the direct communication between the UE and the network entity via the relay so that such a communication is not supported, while the a single-hop wireless connection over the relay device, like a satellite or any other wireless signal forwarding element or device, may be basically possible. This problem is due to the fact that the relay device is configured or preconfigured such that the first bidirectional link 134 (see FIG. 3) and the second bidirectional link 136 use a first interface for a communication with a radio access network, RAN, of the wireless communication network, e.g., the Uu interface. Thus, the relay resources allocated for a communication on the first and second bidirectional links 134, 136 are only for a Uu communication. The present invention addresses the problem by allowing the UE to direct communicate the network entity of the wireless communication network via the relay device on one or more the first relay resources, i.e., on the first bidirectional link 134, or on one more of the first and second relay resources, i.e., on the first and second bidirectional links 134, 136, using a second interface for a device-to-device, D2D, or sidelink, SL, communication in the wireless communication network, e.g., the PC5 interface.

In other words, the UE and the destination entity may communicate directly with each other via the relay device using the relay resources which were originally or initially allocated by the system for the communication of the relay device with the RAN on the bidirectional links. In other words, some or all of the relay resources used for the Uu communication to/from the relay device may be used by the UE for a direct connection to the network entity. In accordance with embodiments, the UE may perform a sidelink communication with the network entity according to the existing 3GPP sidelink communication protocol framework on some or all of the relay resources allocated for the Uu communication to/from the relay device.

Embodiments of the present invention are now described in more detail with reference to the accompanying drawing. It is noted that the subsequently outlined and described aspects or embodiments may be combined such that some or all of the aspects/embodiments are implemented within one embodiment. Further, it is noted that when referring to “resources”, in this description, a resource is to be understood as comprising one or more of the following:
one or more symbols,
one or more time slots or subframes or frames,
one or more frequencies or carriers or subchannels or group of subchannels,
one or more interlaces,
one or more resource block sets, RB sets,
one or more frequency bands, like unlicensed subbands,
one or more bandwidth parts,
one or more resource pools,
one or more LBT sub-bands,
one or more spatial resources, e.g., using spatial multiplexing.

Furthermore, it is noted that when referring to “a set of resources”, in this description, a set of resources may contain one or more than one resource, with the definition of a resource as mentioned above. Moreover, it is noted that when referring to a “channel”, in this description, this may refer to a set of the resources as mentioned above. Thus, a “channel” may also refer to a sub-channel, a sub-band, an RB set, an interlace, a resource pool or a SL BWP.

In accordance with embodiments of the present invention, the problems encountered in conventional approaches are addressed by providing an approach allowing a user device, UE, to perform a direct communication with a network entity of the wireless communication network via a relay device on its relay resources which, initially, were scheduled or allocated by the system for bidirectional links provided by the relay device using a first interface for a communication with the RAN, like the UU interface. The UE is allowed to make use of the relay resources for performing a direct communication using a second interface for a device-to-device or a sidelink communication, for example using the PC5 interface. In other words, embodiments of the present invention provide an approach in which a UE is allowed to perform a sidelink communication using the relay resources allocated to a RAN relay device, like a satellite. This overcomes the above mentioned problems encountered in situations in which a UE intends to make connection to another network entity but may not connect to a RAN of the wireless communication network or loses the connection, or in case an existing sidelink communication is lost may not at all be established, or in case the relay device, like the satellite, loses its connection to the RAN to which the UE is connected.

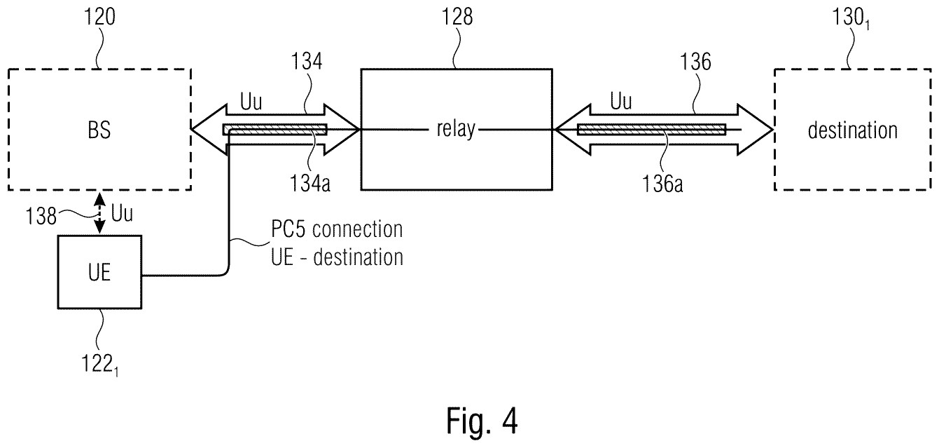

FIG. 4 illustrates a wireless communication network, like a third generation partnership project, 3GPP, network in accordance with an embodiment of the present invention. The wireless communication system includes the UE 122₁ and the relay device 128. The relay device provides a first bidirectional link 134, like an access or service link. The first bidirectional link 134 comprises first relay resources and uses a first interface, like the Uu interface, for providing a communication between the relay device 128 and the radio access network, RAN, of the wireless communication network, e.g., to/from a first RAN entity such as the base station 120 illustrated in FIG. 3. The relay 128 provides a second bidirectional link 136, like a backhaul or feeder link, which comprises second relay resources and uses also the first interface, like the Uu interface, for a communication to/from the RAN, e.g., to/from a second RAN entity such as the base station 130₁ illustrated in FIG. 3. For example, the wireless communication network may configure or preconfigure the relay device 128 with the first and second relay resources for a communication using the Uu interface to/from the RAN entities 120 and 130₁, for example for connecting a user device and a base station as described above with reference to FIG. 2. In accordance with the inventive approach, UE 122₁ performs a direct communication with another network entity, e.g., the base station 130₁ or with another UE, via the relay device 128 on one or more of the first relay resources 134a or on one or more of the first and second relay resources. In other words, in accordance with embodiments of the present invention, one or more of the first relay resources 134a for the first bidirectional link 134 are now employed by UE 122₁ for performing a direct communication towards the relay device 128 using the second interface, like the PC5 interface for establishing a device-to-device, D2D, or sidelink, SL, communication. Thus, the resources on the link 134, initially allocated to the Uu interface, are now used by the PC5 interface. In accordance with embodiments, the second link 136 may remain as initially configured, i.e., provide a Uu connection to the network entity 130₁. However, in accordance with other embodiments, also on the second link 136 one or more of the second relay resources 136a may be used for performing a communication using the PC5 interface.

In accordance with embodiments, the access link 134 between BS 120 and relay device 128 uses particular radio resources. These radio resources are the same resources which are used to connect the UE with the relay device. The access link resources may be operated in FDD mode. Also the backhaul link 136 may be operated in FDD mode, and in this case the access link uses two frequencies (FDD) and the backhaul link uses the same frequencies for backhaul (FDD). If UL and DL refer to “towards or from” the RAN then the access and backhaul mapping are identical on the F1 and F2 as FDD bands. In case the access link and backhaul link use different bands, e.g., the backhaul might use a different band combination or a laser link pair, the relay shortcuts or bridges the access links and forwards one through the other FDD band (outbound repeater mode) or on itself (inband repeater mode).

Allowing the UE to access the relay station 128 via the sidelink communication interface is advantageous as once the one or more relay resources that may be used for such a sidelink communication are known, the UE may simply apply the sidelink communication protocol, for example using the 3GPP standardization framework, for establishing the communication over the relay station without the need for the required access procedures to be performed when establishing a communication over the Uu interface, like a RACH procedure. Thus, embodiments of the present invention provide a simple and easy to implement approach allowing a sidelink communication between a UE and another entity over a relay device, for example in case a direct connection to the other entity is not possible or is lost, in case a relay device was originally used but lost its connection to the RAN so that a direct connection needs to be established via the relay device only, or in case the UE may not access the RAN to which it may belong, for example because it lost a connection or may not establish a connection to a base station of the RAN to which the UE belongs.

Embodiments of the present invention address the problem that
a communication between the UE 122₁ and the destination entity 130₁ may not be possible at all, for example due to a failure on the link 138 between UE 122₁ and the base station 120, or due to a failure of a connection between the base station 120 and the relay device 128 on the access link 134, or
desired requirements of a communication, like a desired QoS, between the UE 122₁ and the destination entity 130₁ may not be achieved, e.g., due to the limited capabilities on the link 138 and/or on the access link 134.

In other words, in accordance with embodiments dependent on a certain event or situation, UE 122₁ may use the relay resources for establishing a direct connection to the destination entity 130₁, thereby circumventing or bypassing the insufficient or failed links. In other words, responsive to the certain event or in a certain situation, the UE may terminate its communication with the base station 120 and initiate a direct communication, using for example the sidelink communication protocol, with the destination entity via the relay device 128 using some or all of the relay resources initially allocated for a Uu communication between the base station 120 and the relay device 128 on the access link 134.

In accordance with embodiments, the UE may operate using the inventive approach responsive to a loss of the connection over the link 138 between the UE 122₁ and the base station 120, or that such a connection may not be established. Another event may be that the link 138 and/or the access link 134 do not provide the desired communication requirements, such as a desired quality of service, QoS, for example because a latency, a bandwidth or capacity or data rate of a backhaul connection or an end-to-end reliability is not sufficient for obtaining the desired QoS.

UE 122₁ may also switch to the direct communication using the relay resources responsive to a signaling from the base station 120 or responsive to a signaling from the relay device 128. For example, the base station 120 may recognize that the connection 138 does not allow for achieving the desired communication requirements, or that a connection 134 to the relay device 128 is lost or may not be established. In such events, the base station 120 uses the link 138 for signaling this situation to the UE 122₁ which, responsive thereto, initiates the direct communication via the relay device 128.

In accordance with further embodiments, also the relay device may signal the UE 122₁ to initiate the direct communication via the relay device 128, for example when the relay device 128 recognizes that the connection to the base station 122 is lost or may not be established so that the backhaul connection between the base station and the wireless communication network is lost or may not be established.

In accordance with other embodiments, the UE may perform the direct communication 150 via the relay device 128 in case some of the relay resources on the access link 134 or on the access link 134 and on the backhaul link 136 are unused, for example due to a lack of regular Uu transmissions. Such unused resources may be used by the UE 122₁ for the direct connection via the relay device 128. This embodiment increases the efficiency of the use of the spectrum by avoiding resources allocated for the access link 134 and/or the backhaul link 138 to remain unused.

In accordance with further embodiments, when the UE is connected to the base station 120 serving the UE and providing an indirect communication between the UE and the network entity via the relay device so that a connection between the UE and the network entity is established, the UE may perform only the direct communication with the network entity, or may perform the direct communication with the network entity in addition to the indirect communication with the network entity. Stated differently, the direct communication via the relay device 128 may be performed instead of a communication via the links 134, 136, 138 or in addition to this communication. In other words, in case the link from the UE via the base station and the relay device to the destination entity exists and provides the required QoS requirements and in case an additional direct communication providing for the same requirements is possible due to the presence of unused additional resources, UE 122₁ may establish a connection to via relay device and via the base station 120 and, in parallel, the direct communication via the relay station 128.

Further embodiments of the present invention are now described with reference to wireless communication systems, like a 3rd Generation Partnership Project, 3GPP, network, using as a relay station a satellite via which a UE performs a direct communication with another UE or with a base station. However, it is noted that the present invention is not limited to such embodiments, rather the inventive approach may be implemented also in other wireless communication systems, provide for a direct communication between the UE and different network entity via any other kind of relay device.

In accordance with embodiments, the wireless communication network comprises a Low Power Wide Area network, LPWAN, like a LoRA, network or moiety network, or a Wi-Fi network.

In accordance with embodiments, the relay device may be (i) a moving or stationary ground-borne device, like a relay, a repeater, a vehicle mounted relay or repeater, or a reconfigurable reflected surface, RIS, or (ii) a moving or stationary liquid-borne device, e.g., on or in water such as a ship or a submarine, like a relay, a repeater, a vehicle mounted relay or repeater, or a reconfigurable reflected surface, RIS, or (iii) a moving or stationary air-borne device, like a drone, an unmanned aerial vehicle, UAV, or an airplane or helicopter, or (iv) a moving or stationary space-borne device, like a low earth orbit, LEO, satellite, a medium earth orbit, MEO, satellite, or a geosynchronous earth orbit, GEO, satellite.

In accordance with embodiments, the network entity may comprises one or more of the following:
a further BS,
a roadside unit, RSU,
an orbital side unit, OSU, the orbital side unit exchanging information with passing satellites or airplanes,
a mobile BS mounted on a land or water vehicle, e.g., a car, a bus, a train, a ship or vessel, a submarine, or mounted on a container or on any piece of equipment mounted on or attached to the vehicle,
a mobile BS mounted on a non-terrestrial or air-borne vehicle or device, e.g., an aircraft, a UAV, a balloon, a rocket, a satellite or any other object or device moving or floating in 3D-space without being in touch with the surface of a planet or a liquid on the planet, e.g. water of a lake or the sea,
a further UE,
a Customer Premises Equipment, CPE
an IoT device,
a broadcast tower like one used for digital audio (radio) or Television (video) broadcast,
a relay device,
a further relay device,
a core network,
a function located somewhere in the communication network, e.g., a UPF, LMF, AMF, SMF etc.,
an application server connected to the core network,
an aggregation node for, e.g., storage, processing (fusion, decision making, computing outputs) or forwarding of sensor data, messages, retransmissions, AIM, measurements reports, configurations etc.,
a database.

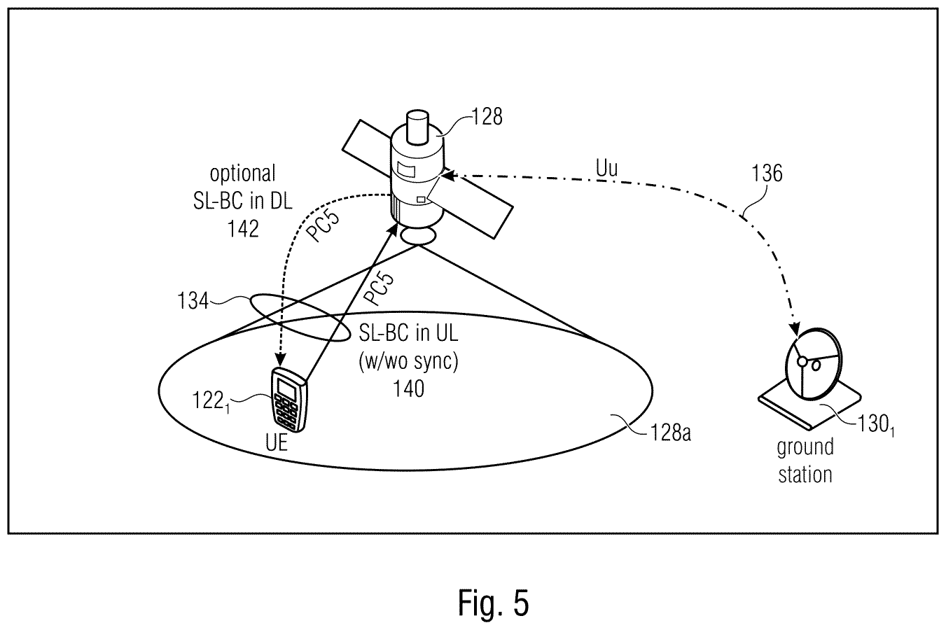

FIG. 5 illustrates a wireless communication system in accordance with embodiments of the present invention using as the relay device 128 a satellite. The wireless communication system may include terrestrial components, like a base station (not illustrated) and the destination entity 130₁, as well as NTN components, like a NTN gateway (not illustrated) and the satellite 128. In case UE 122₁ has no connection to the base station, it establishes a direct communication with the destination entity 130₁ via the satellite 128 using the link 134. For example, the base station may be out of service or not available for other reasons, or UE 122₁ may be out of coverage of the base station. UE 122₁ is assumed to be located within the coverage area 128a of the satellite 128 and, responsive to detecting the lack of connection to the base station, may determine whether the satellite 128 is available or whether it becomes available. In other words, UE 122₁ is aware of the availability or the expected availability of the satellite 128. Once UE 122₁ determines that the satellite 128 is available, UE 122₁ may send a messaging information on the satellite's service link 134 resources using an uplink sidelink broadcast, SL-BC, 140 to the satellite 128 which is not necessarily synchronized. For example, if the UE 122₁ is capable of supporting a NTN communication, the UE 122₁ may establish a connection accordingly via the satellite 128 to the ground station 130₁. In case the UE is not capable of accessing the satellite network in a synchronized way according to the NTN protocol specification, the UE may use a sidelink (SL-BC) communication via the satellite 128 to the ground station 130₁. A relevant scenario may be an emergency scenario wherein the UE wants to send a distress/emergency message to the ground station 130₁ using radio resources of the satellite service link 134 usually used in the Uu link by UEs communicating in accordance with the NTN protocol via the satellite 128 with the ground station 130₁. The UE intending to send a distress message is using resources of the satellite service link 134 for SL-BC messages. These messages may contain information about the location of the UE, circumstances about the emergency situation, requested actions by responders, etc. Beyond the emergency situation related message part, another message part may relate to a response from the ground station via the satellite using SL-BC which may contain an acknowledge of the distress message, configuration information regarding further communication via the satellite, e.g., band allocation, frame structure indication including slot structure, band allocation and other transmission/reception related configuration information to allow further and/or enhanced communication via the satellite. Such messages requested by the UE and further responded by the ground station may be considered any kind of Assisting Information Messages, AIM, targeted to facilitate the communication of the UE via the satellite using the SL-BC (PC5). The satellite 128 is connected to one or more ground stations 130₁ via the feeder link 136 which operates using the Uu interface and forwards the messaging information to the ground station 130₁. UE 122₁ sends the SL-BC 140 using radio resources usually used for the access link between the base station and the satellite 128. The embodiment of FIG. 5 may be advantageous as a UE which is not capable of operating using the NTN protocol may still transmit a certain message, like an emergency message, via a satellite to a NTN ground station. In accordance with further embodiments, the satellite 128 may forward a response from the ground station 130₁ via a downlink SL-BC 142, again using radio resources usually used for the access link. In the depicted embodiment, the response is received at the satellite 128 on the feeder link using the Uu interface.

In accordance with embodiments, UE 122₁ may be a NTN capable UE, i.e. a user device having the capabilities/circuitry for directly connecting to the satellite 128. For example, n NTN UE may include, in addition to the circuitry for connecting to the RAN, for example using the 3GPP standard, also the components used for establishing a connection to the satellite, for example it may include the ground station for the satellite in the form of the NTN gateway.

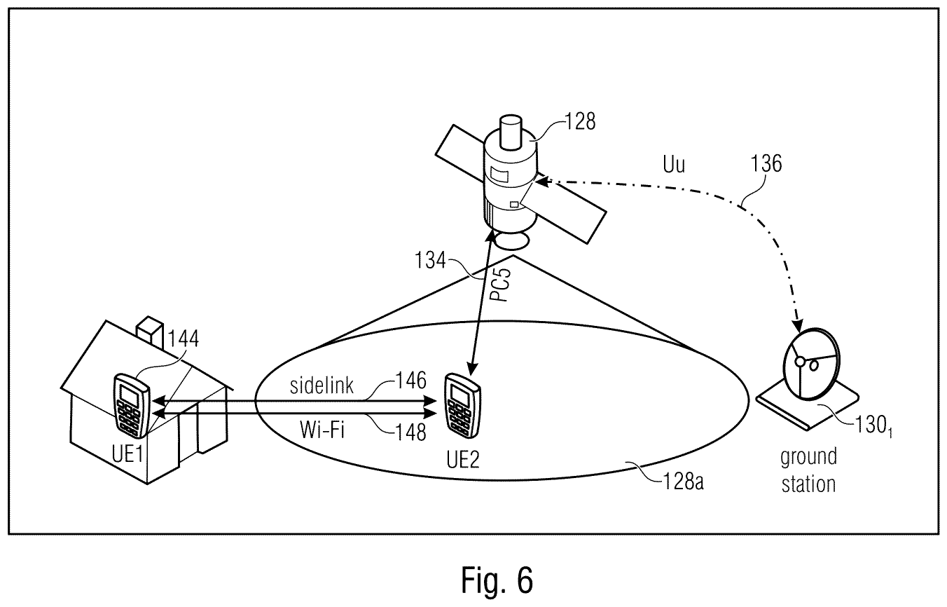

FIG. 6 illustrates a further embodiment of the present invention according to which UE 122₁ acts as a relay UE for a remote UE 144. UE 122₁ may have a plurality of RAT capabilities, e.g., a first RAT capability for providing a SL connection 146 with the remote UE 144 using sidelink resources of the wireless communication network. It is notated that the sidelink resources are different from the first and second relay resources, and a second RAT capability for connecting the remote UE and the UE via a network connection 148 of a network different from the wireless communication network, e.g., Wi-Fi or Bluetooth. In accordance with other embodiments, UE 122₁ and the remote UE 144 may be subscribed, in addition to the wireless communication network, to one or more further networks so that the UE 122₁ and the remote UE 144 may be connected via the wireless communication network providing the SL connection 146 between the UE 122₁ and the remote UE 144 using the sidelink resources of the wireless communication network, and/or by one or more of the further networks 148, e.g., Wi-Fi or Bluetooth.

The embodiment of FIG. 6 may be advantageous in situations in which the remote UE 144, namely UE1 in FIG. 6, is aware of the availability or the expected availability of the satellite 128 but may not be in a position to connect to the satellite 128, for example because it is located outside the coverage 128a of the satellite 130₁, as depicted in FIG. 6, or in a situation in which UE1 is located within a building so that, despite the fact that it is within the coverage 128a of the satellite 130₁, a communication to the satellite is not possible. In such a situation, UE1 may establish the direct communication to the ground station 130₁ via the satellite 128 using UE 122₁, UE2, which is located within the coverage 128a of the satellite 128 and is capable of connecting to the satellite 128. The direct communication, in such an embodiment, is a two-hop connection including the first hop 146/148 for connecting to UE2, which, in turn, provides for the second hop 140b of the direct communication 140 via the satellites to the destination. Thus, in accordance with FIG. 6, a situation or scenario is addressed in which UE1 is not to access the satellite 128. UE1 establishes the sidelink connection 146 or the Wi-Fi connection 148 to UE2 which acts as a forwarding agent since it has access to the satellite 128.

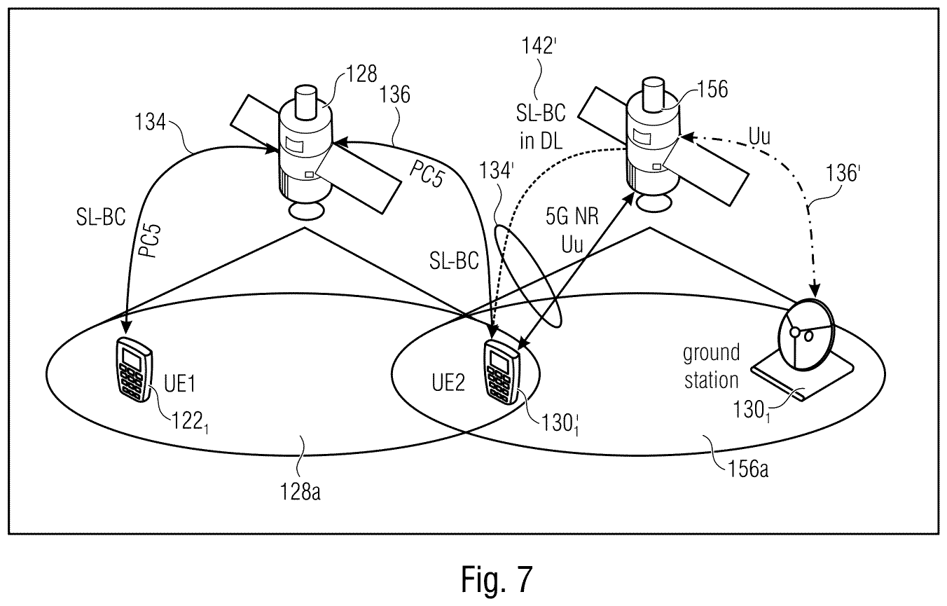

In accordance with further embodiments, a chained connection between the UE 122₁ of FIG. 5 and a destination, like a ground station may be established. FIG. 7 illustrates an embodiment of a chained connection of satellites to reach a destination which is connected to the core network of the wireless communication system. FIG. 7 illustrates a situation similar to the one described above with reference to FIG. 5, i.e., it is assumed that UE 122₁, UE1, may not access the RAN and, therefore, in accordance with the inventive approach, establishes the direct communication via the satellite 128. Other than in FIG. 5, the feeder link 136 of the satellite 128 is not directed to the ground station 130₁ directly, rather, it is directed to an intermediate destination 130₁′ which may be a further UE, like UE2 illustrated in FIG. 7, and which is located in the coverage 128a of satellite 128 and also in the coverage 156a of a further satellite 156 connecting UE2 via the further service link 134′ and via the further feeder link 136′, both operating using the Uu interface, to the ground station 130₁ which, in turn, is connected to the core network 102 of the wireless communication system. In accordance with embodiments, the further satellite 156 may relay a response message from the ground station to UE2 using a SL-BC, as indicated at 142′. In the scenario depicted in FIG. 7, UE1 and UE2 are within coverage of the first NTN satellite 128 which itself is not connected to the network. However, UE2 is within the coverage footprint of the first satellite 128 and the second satellite 156 so that UE1 and UE2 may use a sidelink communication via the first satellite which serves as a sidelink signal repeater between the UE1 and the UE2.

The above described embodiments are advantageous as a UE is enabled to establish a direct communication with another network entity, like a base station or another UE, via the satellite 128 using the sidelink communication protocol, thereby avoiding the procedures entailed, like a RACH procedure, for setting up a connection over the Uu interface.

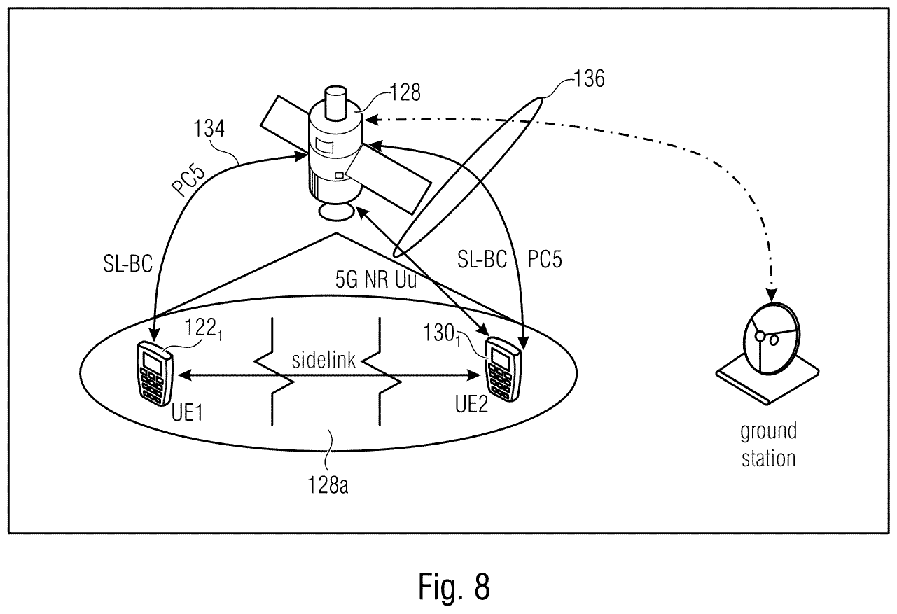

In the embodiments described above with reference to FIGS. 5 to 7, it was assumed that the UE lost a connection to a RAN, however, the UE may also take advantage of the inventive approach in case a sidelink communication with another UE in the same RAN is no longer possible. FIG. 8 depicts an embodiment, wherein UE2 is connected via 5G-NR NTN using the Uu interface over the satellite 128 to the NTN base station 130₁ (ground station). Furthermore, UE1 which is within coverage 128a of the satellite 128 and is communicating with UE2 over the sidelink via the satellite only since the terrestrial sidelink between UE1 and UE2 is not operable because, for example, the UEs are too far apart. Here, UE2 serves as a sidelink relay/remote UE within the single hop framework of 5G-NR. UE1 can be connected to the internet using UE2 as a L3 relay, e.g. if UE1 is not subscribed to the NTN network provided by the satellite. Both connectivity options, 5G-NR remote UE/sidelink relay and SL-hotspot may require a priori configurations that such transmission and relaying schemes are supported and available.

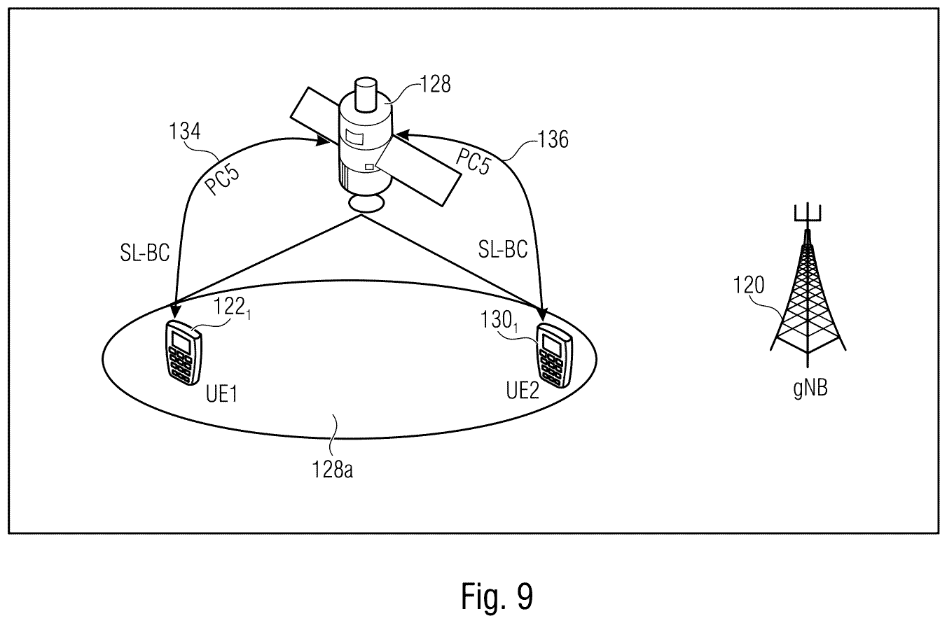

FIG. 9 depicts an embodiment of a communication system, wherein UE1 and UE2 are out of coverage from a terrestrial network but within the coverage footprint 128a of the satellite 128 wherein the satellite 128 is not providing the “usual” or regular NTN connectivity via Uu and/or the UEs have no NTN capabilities but SL-capabilities instead. The UEs use the satellite radio resources to communicate in accordance with the inventive approach with each other via the satellite using SL-BC.

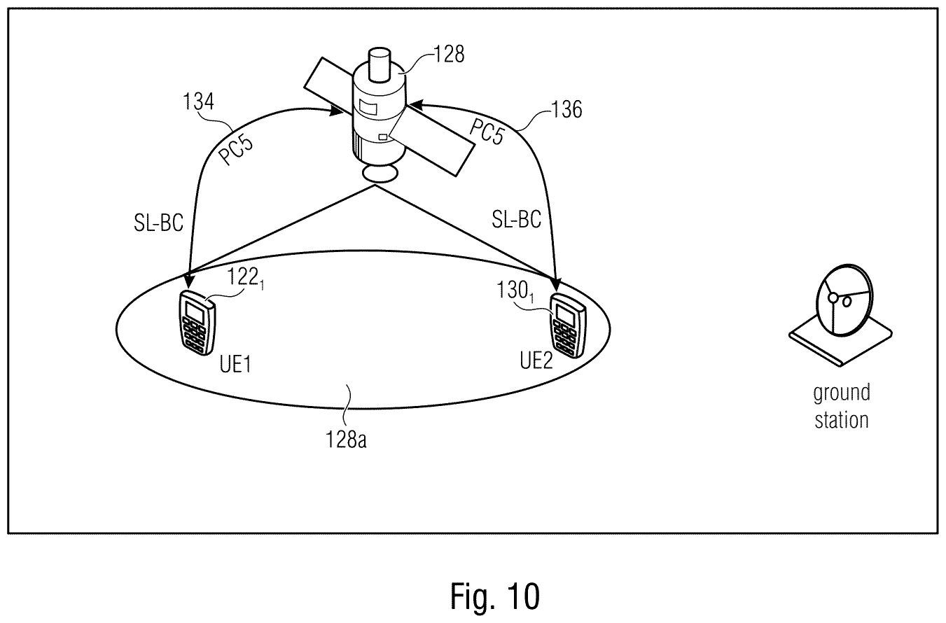

FIG. 10 depicts an embodiment of the communication system, wherein UE1 and UE2 are out of terrestrial coverage but within coverage footprint 128a of the NTN satellite 128 wherein the satellite itself is not connected to the network (ground station) and may be considered to be similar to an IAB access node with a temporarily non-existing backhaul to the CU and/or core network. While the satellite is not connected directly or indirectly to the ground station, UE1 and UE2 are within the coverage footprint of the satellite and UE1 and UE2 are using a sidelink communication in accordance with the present invention wherein the satellite serves as a sidelink signal repeater between the two UEs. The sidelink communication between the UEs utilizes radio resources supported by the satellite in forward (downlink) and or reverse link (uplink) during normal operation mode wherein the satellite is forwarding the Uu downlink from the ground station to the UEs in the so-called forward link and the Uu uplink from the UEs to the ground station in the so-called reverse link. Using the temporarily unused Uu radio resources for sidelink communication allows connectivity between the UEs with high autonomy, relying on knowledge about available radio resources which can be configured a priori or find out by sensing/probing with and or without additional knowledge e.g. about potential availability of satellites and or used/allocated spectrum for satellite communication. Using sidelink (SL) the UEs communicate directly via SL in TDD, FDD and/or Full Duplex (FD) fashion taking extended RTT over the satellite-SL-relay into account. Furthermore, such autonomous SL mode between UEs in NTN coverage without NTN backhaul (therefore no NTN-Uu available) can be preconfigured via e.g. RRC from a ground station, triggered by an event (loss of downlink signal from NTN satellite), beaconing from the satellite when out of backhaul to a ground station or any combinations thereof.

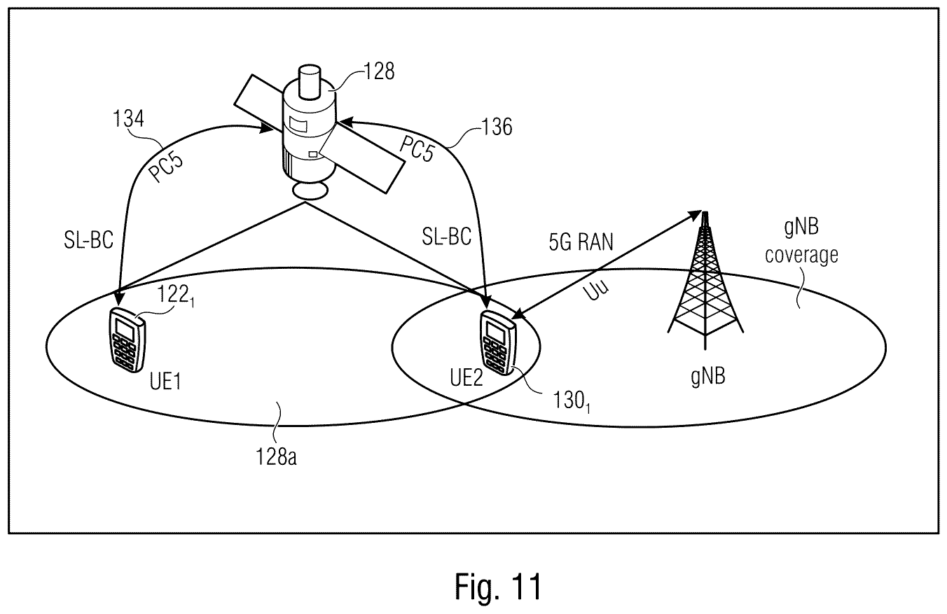

FIG. 11 depicts a further embodiment, wherein UE1 and UE2 are within coverage 128a of an NTN satellite 128 wherein the satellite itself is/is-not connected to the network (ground station)—see the two scenarios described with reference to FIG. 9 and FIG. 10. Furthermore, the UEs are not inter-connectable via NTN Uu, e.g. the satellite 128 might have lost backhaul and/or the UEs are not subscribed to the same network. While the satellite is not connected directly or indirectly to the ground station, UE1 and UE2 are within the coverage footprint of the same satellite so that UE1 and UE2 are using sidelink communication according to the inventive approach via the satellite, i.e., the satellite serves as a sidelink signal repeater between the two UEs. Furthermore, the second UE serves as SL-relay/remote UE within its connectivity to its 5G-RAN (terrestrial RAN). The SL resources used by UE1 and UE2 for SL-BC may be preconfigured by the NTN and/or by the TN. Another alternative implementation option of the relaying functionality provided by UE2 could be an L3 relaying similar to a Wi-Fi hotspot, wherein instead of Wi-Fi as a RAT, 5G-NR SL-BC is used for the communication between UE1 and UE2 and 5G-NR Uu between UE2 and the gNB, wherein UE1 is basically internet connected via a provided internet connection from UE2 but is not terminated in the 5G-RAN provided by the gNB, therefore UE1 does not to be subscribed to the same 5G-NT like UE2.

In accordance with embodiments, the UE may communicate directly via the sidelink in TDD, FDD and/or FD fashion, taking the extended roundtrip time, RTT, over the satellite 128 into account. The autonomous SL mode between the UE and the destination without an NTN backhaul, i.e., in case no NTN-Uu is available, may be preconfigured, for example via RRC signaling from a ground station, may be triggered by an event, like the loss of downlink signal from the NTN satellite, responsive to a beaconing from the satellite to the ground station, when the satellite is out of backhaul.

In accordance with embodiments of the inventive approach, the UE may establish the direct connection to the destination via the satellite using relay resources which are at least temporarily unused. The use of the temporarily unused relay resources for the sidelink allow for a connectivity between the UE and its destination with a high autonomy relying on the knowledge about available resources which may be configured á priori or found out by sensing or probing with and/or without additional knowledge, for example about potential availabilities of the satellite. Further a more efficient use of the spectrum allocated for a satellite communication is achieved in case only part of the spectrum is used. Thus, if the relay device or satellite communicates with the RAN via the access and backhaul links, i.e., provides for backhaul capabilities to the RAN, but the current or future traffic results in a spectrum under-utilization, a direct communication via the relay station may be realized using the unused resources. Other than conventional approaches in which the FDD bands on the access and backhaul are fixed for the Uu communication, he inventive approach avoids spectrum under-utilization, like unused frequency bands, as they may be used for other the direct communication purposes. In accordance with further embodiments of the present invention, such unused spectral and/or temporal resources. In accordance with embodiments, one or more subbands, bandwidth parts, subframes, slots, time transition intervals, TTIs, SPS or symbols may be used for establishing the inventive direct communication between the UE and the relay device or satellite.

In the following, further embodiments of the present invention are described which make use of the above-mentioned unused resources, i.e. of resources allocated for the service link and the feeder link and that may be unused for some time, for example because some of the entities making use of the respective links do not have anything to transmit. For providing a more efficient use of the spectrum, i.e. for avoiding unused resources, in accordance with embodiments, as described above with reference to FIG. 4, UE 122₁ may establish a direct connection 140 via the relay device using such unused relay resources either in addition to the regular connection via the base station or instead of this connection.

When considering a relay communication, for example a satellite communication using a FDD configuration, embodiments of the present invention provide further improvements of such a configuration. When assuming a conventional FDD configuration, there is provided a paired spectrum allocated for the satellite communication on the access link or on the access and backhaul links using spaced-apart frequency bands for a uplink transmission towards the relay device and for a downlink transmission by the relay device. In accordance with embodiments, one or more or all of the FDD bands may be structured in such a way that non-incumbent traffic is mapped to selected temporal and/or spectral resources of the frequency band or frequency subband. Some resources, like subframes, SPS, symbols may be free or substantially free of incumbent traffic in either downlink or uplink, meaning that a percentage of the incumbent traffic on the resources is only a predefined percentage of the overall traffic, for example below 10% or less. The mentioned incumbent traffic includes UL and/or DL traffic using the first interface from/to one or more other network entities on the first bidirectional of the relay device, and/or UL and/or DL traffic using the first interface from/to one or more other network entities on the second bidirectional of the relay device. In accordance with other embodiments, one or more of the FDD bands may be configured such that incumbent traffic is excluded from such frequency bands or subbands, for example in a particular bandwidth part BWP. When only a low percentage of the traffic in a frequency band is associated with incumbent traffic, those resources not carrying the incumbent traffic may be used for the sidelink via the satellite. When a certain frequency band is free of incumbent traffic, the entire frequency band or BWP may be used for the sidelink between the UE and the destination via the satellite.

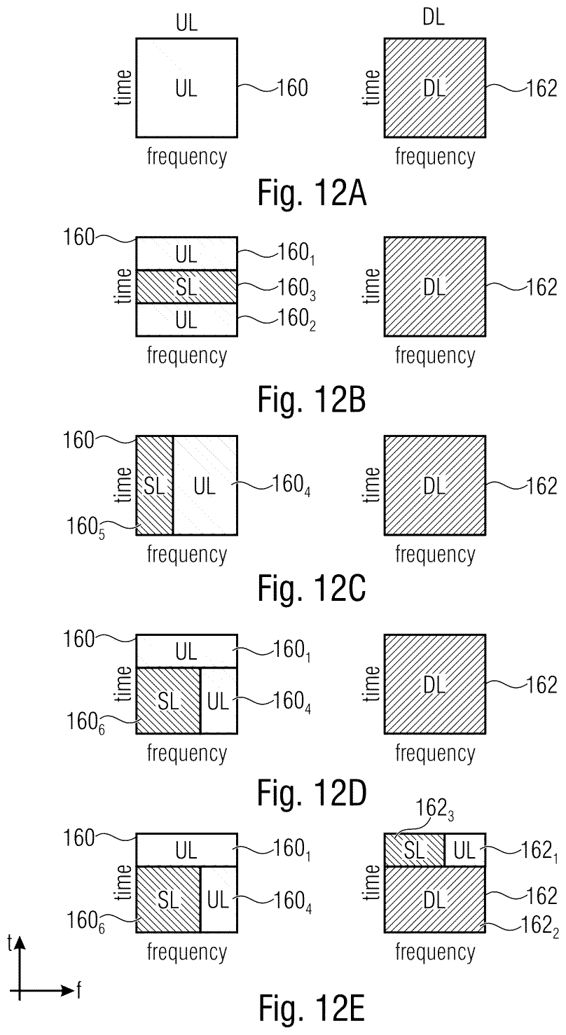

FIG. 12A to FIG. 12E illustrate embodiments of the sub-structuring of the FDD bands or subbands to be used for establishing a sidelink communication via the relay device. FIG. 12A to FIG. 12E illustrate on the left side the uplink band or subband and on the right side the downlink band or subband. FIG. 12A illustrates the conventional approach of a FDD band allocation for a satellite communication on the access link or on the backhaul link in which the first frequency band 160 is only used for uplink transmissions while the second frequency band 162, separated in frequency from the first frequency band 160, is used only for downlink transmission. However, as stated above, during satellite communications it may be that not the entire resources in the frequency bands 160, 162 are used for a communication, and such temporal unused resources may be used for performing the direct communication between the UE and the destination via the satellite in a way as described above with reference to FIGS. 4 to 7. In accordance with the embodiments of FIG. 12B to FIG. 12D, the uplink frequency band 160 may be used, in part, for a sidelink communication, whereas the downlink frequency band 162 is only used for downlink transmissions. In the embodiment of FIG. 12E both the uplink and downlink bands 160, 162 may partially be used for a sidelink communication.

In accordance with the embodiment of FIG. 12B, the UL band 160 is subdivided into UL slots 1601 and 1602 for a regular FDD satellite communication, while the frequency band 1603 which is assumed to be free or substantially free of any communications in the uplink may be used for the sidelink communication. FIG. 12C illustrates an embodiment in which the UL band 160 is subdivided into one or more bandwidth paths 1604 for a regular FDD satellite communication, and one or more bandwidth parts 1605 to be used for the sidelink communication via the satellite. In the embodiment of FIG. 12D, the uplink band 160 is subdivided into one or more UL slots 1601 and one or more UL bandwidth parts 1604 which are used for a regular FDD satellite communication, while one or more particular slots 1606 of a particular bandwidth part are used for the sidelink communication. Thus, FIG. 12D is basically a combination of the embodiments of FIG. 12B and FIG. 12C in the uplink band. FIG. 12E illustrates an embodiment which is basically a combination of the embodiments of FIG. 12B and FIG. 12C both in the uplink band and the downlink band. The uplink band is subdivided in a similar way as in FIG. 12D, and the downlink band 162 is subdivided into one or more downlink slots 1621 and 1622 with one or more particular slots of a bandwidth part being dedicated for the sidelink communication, as indicated at 1623.

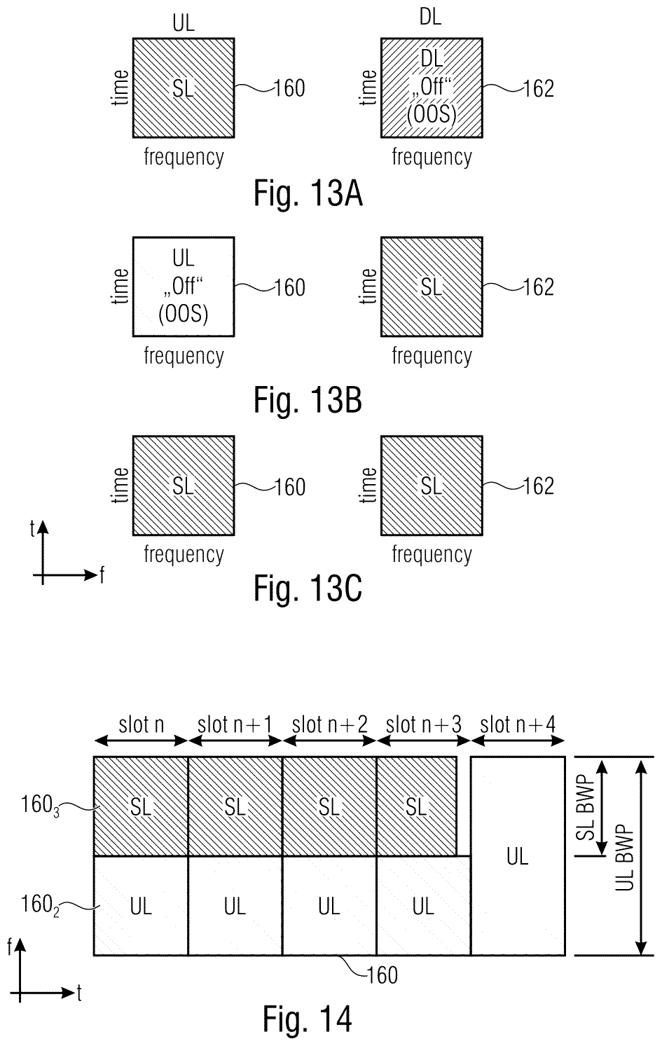

In accordance with further embodiments, the FDD bands for the satellite communication may be allocated for the sidelink transmission dependent on whether the satellite has lost its connection to the ground station, for example the NTN gateway. In such a scenario, the resources, i.e., frequency bands may be used for the sidelink communication. FIG. 13A to FIG. 13C illustrate an embodiment in which an allocated paired spectrum for an FDD operation of a satellite communication system is used for sidelink communication dependent on whether a link to the ground station has been lost. FIG. 13A to FIG. 13C illustrate, in a similar way as FIG. 12A to FIG. 12E, the uplink and downlink bands 160, 162. FIG. 13A illustrates an embodiment in which an out of service situation for the uplink band is assumed, i.e. the satellite has lost the connection on the service link to the base station serving the UE which, therefore, may be use all the resources in the uplink band to be used for a direct communication or sidelink communication with the satellite. In FIG. 13A, it is assumed that the downlink connection in the downlink band is existing on the service link so that this band is not used for sidelink communication. FIG. 13B illustrates an embodiment in which it is assumed that the downlink band has lost its connection to the ground station so that the resources from the downlink band 162 may be used for the sidelink communication while the resources in the uplink band are not used for the sidelink communication. In FIG. 13C it is assumed that both the connections to the ground station in the uplink band and in the downlink band are lost or may not be established so that the resources from both the uplink and downlink bands may be used for the sidelink communication.

In accordance with embodiments, the resource allocation for the sidelink may be assisted by slot format pilots or slot format reference signals, RSs, which are provided by the relay device, like the satellite, or by another entity within the coverage footprint of the satellite including a group leader UE, a slot master UE or the like. If no slot format assistance is provided the sidelink operation may follow the framework of resource pools, like LTE-V2X-SL or fully autonomous with sensing, listen-before-talk, LBT, or group assisted resource allocation. The time frequency resource grid available for the SL communication may be used in different duplex formats and variants, including, but not limited to TDD, FDD, SBFD, half-duplex FDD, half-duplex TDD.

The availability of concurrent uplink and/or downlink traffic via the satellite provide means to synchronize the inventive sidelink operation with a frame or slot structure indicated by allocated resources and/or reference symbols that are broadcast in the downlink and/or uplink band. Such reference symbols in a frame, in a slot or in a symbol may be used as assistance and time/frequency anchors for the allocation of radio resources provided for a concurrent sidelink communication in the uplink and/or downlink bands used by the satellite communication.

In accordance with further embodiments, an existing downlink control channel may be used to signal to sidelink capable UEs and to legacy UEs additional information with respect to the resources, like the BWP, the slots, the RBs and the like, which are temporarily or semi-statically provided for the sidelink communication. FIG. 14 illustrates an example for using resources in the uplink/downlink bands for a sidelink communication. The uplink frequency band 160 is divided into the uplink bandwidth part and the sidelink bandwidth part, as is indicated at 1601 and 1602 for slot n to slot n+3 whereas the slot duration in time may be the same or different, as is shown at slot n+3. Slot n+4 is only for the uplink data. The structure depicted in FIG. 14 may also be referred to as sidelink bandwidth path operated in uplink band, as SL BWP in UL. FIG. 14 presents an example of what, in accordance with embodiments of the invention, may be referred to as a “sidelink bandwidth part operated in uplink band (SL BWP in UL).

As described above, embodiments of the present invention address problems encountered in the wireless communication system, in case the UE is not able to establish a communication link with one or more other entities of the RAN. Such network entities or destination entities may include one or more of the following:
a further base station, BS,
a roadside unit, RSU,
an orbital side unit (equivalent of a roadside unit, where satellites or airplanes pass by and can exchange information with the RSU)
a mobile BS mounted on a land or water vehicle e.g., a car, bus, train, ship/vessel, submarine or on a container loaded thereon or on any piece of equipment mounted on or attached to the vehicle
a mobile BS mounted on a non-terrestrial/air-borne vehicle or device e.g., an aircraft, UAV, balloon, rocket, satellite or any other object/device moving/floating in 3D-space without being in touch with the surface of a planet or a liquid on the planet (e.g. water of a lake or the sea)
a further UE,
a Customer Premises Equipment, CPE
an IoT device,
a broadcast tower like one used for digital audio (radio) or Television (video) broadcast a relay device,
a further relay device,
a core network,
a function located somewhere in the communication network, e.g., a UPF, LMF, AMF, SMF etc.
an application server connected to the core network,
an aggregation node for e.g., storage, processing (fusion, decision making, computing outputs) or forwarding of sensor data, messages, retransmissions, AIM, measurements reports, configurations etc.,
a data base.

To cope with such scenarios, the UE may communicate directly, using the PC5 interface, with the desired destination via the relay device as has been described above in more detail. The non-establishment of the communication link with other entities of the RAN may be due to an inadequate coverage of the base station in remote, isolated, block, shaded, or otherwise strongly attenuated environments, or due to a reduced availability or a complete unavailability of communication resources, due to access link limitations, due to backhaul link limitations, due to control channel limitations or due to an imbalance in the uplink and downlink transmissions. The issues regarding the inadequate coverage are also referred to as in coverage, IC, or out of coverage OOC, scenarios whereas the availability of communication resources is referred to as in-service, IS, or out of service, OOS. The mentioned resource limitations may refer to a reduced availability or a complete unavailability of:
an access link, like a Uu link, a NTN link, a side link/PC5 link, a missing SSPS, a Wi-Fi link
a backhaul link
a relay link,
a control link in the access link or the backhaul link, a link imbalance, like downlink transmissions versus uplink transmissions,
a link imbalance (downlink versus uplink),
a RIS,
one or more symbols,
one or more time slots or subframes or frames,
one or more frequencies or carriers or subchannels or group of subchannels, one or more subcarriers, e.g., for transmission of IoT messages like NB-IoT, LORA etc.
one or more interfaces,
one or more channels e.g., a control channel, a user data channel or any other channel for a dedicated purpose,
one or more resource block sets, RB sets,
one or more frequency bands, like unlicensed subbands,
one or more bandwidth parts,
one or more resource pools,
one or more LBT sub-bands,
one or more spatial resources, e.g., using spatial multiplexing, directional beams etc.
one or more than one resource,
a sub-channel,
a sub-band.

Since the UE relies on another network entity, like the base station, to provide it with configuration information, like information that includes parameter settings such as power, frequency, modulation, general number, carrier assignment, time-frequency assignment, pattern characteristic and the like, is unlikely to obtain such information due to the conditions mentioned above. The configuration information may include the present and/or future availability, unavailability, shortage/plentifulness of resources relating to one or more of the following:
spatial resources
temporal resources
spectral resources
services provided.

Conventionally, the above problem in known networks concerning a degradation of, an interruption in, a drop of or an unavailability of a communication link may be due to a shortage of communication resources below a level suitable for a required, selected, targeted mode of operation of a communication link with its associated parameters and metrics. Such a situation may be an unexpected change in the wireless communication system, when compared to the regular operation when a connection to the RAN is possible. In accordance with the above described embodiments, while the UE may handle such a situation or unexpected change by implementing the inventive direct communication via the relay device, the UE also needs to be made aware of such a situation or unexpected change so as to improve reliability of communication in wireless communication systems. Therefore, further embodiments of the present invention provide for improvements of the reliability of communication in the wireless communication system when compared to known systems and by making unexpected changes in the wireless communication system, like the above-mentioned loss of connection to the RAN, expected for the UE such that it can react on a changed availability of a resource with respect to a change in the past, the present or in future. According to embodiments of the present invention, the UE is provided with configuration information, CI, that indicates the change of the availability that elsewise, within the implemented, known, communication standard, are unknown to the UE. For example, the configuration information may be provided so as to allow the UE to handle a lost connection to the network using the inventive approach, namely by providing a sidelink connection via the relay device. The UE may obtain the configuration for performing the communication with the network entity via the relay device using one or more of the following:
a pre-set or preconfigured configuration, e.g., a default configuration, a configuration according to factory settings, a recently updated configuration,
based on a last used configuration or a last used mode of operation or a change in a mode of operation, e.g. from a Uu link to a sidelink, from a sidelink to a Uu link, from a Uu link to a relay link, from a relay link to a Uu link, from a SL to a relay link or from a relay link to a SL),
a configuration provided by the network,
a configuration provided by a database, e.g., a database connected to the RAN as an entity,
a configuration provided via an alternative RAN, e.g., via Wi-Fi or Bluetooth,
a configuration provided by a remote UE or a group leader UE,
a configuration provided by a sidelink connection either:
   directly from a further UE connected over the SL with the UE, or
   indirectly from a further UE connected over the SL and via the relay device with the UE.

According to an embodiment, the UE is configured for a communication in the wireless communication system according to a configuration using a resource of the wireless communication system and for using a wireless interface of the UE for the communication, the UE comprising a control unit configured for processing the configuration information indicating a change of an availability of the resource. The configuration information may be available for or transmitted to the UE, e.g., wirelessly received, (pre-) configured, stored thereon, or the like. The control unit is configured for adapting the configuration based on the configuration information to react on the change of the availability, thereby allowing the UE to adapt the configuration to change its behavior in the wireless communication system based on the change of the availability of the resource. e.g., to change from a connection to the destination provided via the RAN and the relay device using the Uu interface to a direct connection to the destination via relay device using the PC5 interface as described above.

According to an embodiment the change relates to an anomalous availability of the resource and/or a significant change of the availability.

According to an embodiment the configuration information leads the anomalous change to be an expected situation for the UE.

According to an embodiment the anomalous availability relates to at least one of:
a time, e.g., being a start, end, period/interval/duration or change of state or change of trend, related to at least one of:
an availability and/or non-availability of the resource,
   an occurrence of a blockage event blocking at least a part of the communication,
   an occurrence of an outage event and/or an outage period of the communication,
   an occurrence of an interference event and/or a jamming event influencing the communication,
   an occurrence of an energy related state and/or a power related state of the communication, e.g., low battery state, recharging time, estimated remaining energy, transmit power constraints due to EIRP restrictions, multi-band operation, interference constraints,
a resource is subject to
   a decrease below a threshold of at least one parameter relevant for the communication,
   an increase above a threshold of at least one parameter relevant for the communication,
   a maintain within or outside a corridor of values of at least one parameter relevant for the communication,
   maintain within or outside a region or area of validity of at least one parameter relevant for the communication with respect to a metric, e.g., coverage, capacity, data rate, reliability, latency,
   a particular distribution, e.g., of parameters and/or states across a dimensions of at least one parameter relevant for the communication using the resource, e.g., in time, frequency, space, directions, location, etc.,
a constraint related to the resource in view of at least one of:
   a provided data volume,
   an allocated spectrum and/or resource block (RB),
   a modulation and coding scheme (MCS) used for the communication,
   a block size used for the communication
   a size of a message, a volume such as data volume or a size of a folder/file and/or a number of messages, e.g., per unit time and/or unit of opportunity,
   a change of any above, e.g., states/values or trends (increase→decrease, decrease→increase),
   a particular or repeated pattern, a distribution, a statistic, a state, a value and/or a trend of occurrence.

According to an embodiment the configuration information relates to an availability of the resource, or to an at least partial unavailability of the resource.

According to an embodiment the configuration information indicates the change of the availability for a past, present and/or future instance of time.

According to an embodiment the control unit is configured for processing the configuration information to obtain a processing result that indicates an at least partial and/or at least temporal unavailability of the resource for the communication, and for controlling the UE to avoid the communication using the resource based on the processing result.

According to an embodiment the control unit is configured for processing the configuration information to obtain a processing result that indicates a restored availability of the resource for the communication and/or that indicates an established availability of the resource, and for controlling the UE to postpone the communication using the resource based on the processing result until the availability of the resource for the communication is restored or established.

According to an embodiment the configuration relates to at least one of:
a transmission, a reception, and combinations thereof provided by the UE as the communication,
a measurement, a logging, a reporting an acknowledging, and combinations thereof to be provided by the UE,
a transmission and/or a reception of at least one preconfigured signal such as a test signal, of at least one preconfigured reference signal, and/or of at least one preconfigured message such as a test message,
a performing of a procedure of transmission of at least one signal and/or a procedure of reception of at least one signal and processing thereof, e.g., beam sweeping, frequency sweep.

According to an embodiment the resource comprises at least one of:
an access link resource, a sidelink resource, a relay link resource and/or a backhaul link resource,
a temporal, spectral, sequential (spreading sequence) and/or spatial communication resource,
a transport channel, a positioning channel, a control channel and/or a data channel, a transmission/reception beam represented by a beam-ID, SSB, CSI-RS, a beam sweep and/or a coordinated beam constellation,
a propagation channel component such as a line-of-sight, LOS, non-line-of-sight, NLOS, obstructed line-of-sight, OLOS, a dominant or specific multi-path component, MPC,
a service or connectivity provided by another UE such as a gNB, core network, access network, repeater, RIS, satellite,
   a quality of service, QoS, related to communication metrics such as coverage, capacity, latency and/or jitter.

According to an embodiment the configuration information comprises at least one of:
information indicating at least one trigger indicating to start or stop a particular action/behavior of the device,
information indicating at least one event which is relevant to the communication scenario,
information indicating at least one condition which describes e.g., the communication scenario, status values/messages of the UE or other network devices,
information indicating a combination or sequence thereof indicating at least one of:
   a state, e.g., of a state machine,
   a status, e.g., of a report, action, confirmation or acknowledgment,
   a period, of a parameter being below/above a threshold or within a range OR a certain state/status is given/valid/invalid,
   an event,
   a request of an action, observation and/or measurement,
   a report relating to an action, observation and/or measurement,
   an action, e.g., of stopping a counter, continuing until something else happens,
   a procedure, to:
      start/pause/continue/end,
      activate/deactivate, and/or
      confirm/acknowledge, e.g., of actions, reports, status.

According to an embodiment the configuration information comprises information indicating an event or trigger, wherein based on the processing, the control unit is configured for controlling the UE responsive to the event or trigger to at least one of:
starting, stopping, resetting and/or halting of at least one counter and/or count-down timer,
capturing, freezing, storing, forwarding a current and/or future, e.g., anticipated state and/or configuration,
an automatic (re)-configuration of the network device and/or its behavior after a trigger, after an event occurred and/or after a condition is met,
starting, halting, delaying, restarting and/or preparing to start a procedure or mode of operation of the UE,
changing from one procedure, routine or mode of operation into another one,
determining or selecting a mode of operation and/or a transmission/reception strategy,
discovering, observing, detecting, monitoring and/or tracing an events and/or a parameter related to any of the above configuration information and/or associated actions, triggers, configuration variants thereof, as an example a UE may be observing pattern of availability of one or more beams based on RS or beam-ID and determining or reporting future availability, based on this another device e.g., a gNB or RIS can be configured to go/remain in particular configuration states such that a certain coverage/capacity requirement of a particular UE is fulfilled,
preparing a transmission and/or reception of at least one of a report, a message, control data and user data, for preparing of a future, e.g., subsequent or next connection availability events.

Although having a related or even similar meaning, some differences may be formulated, at least in connection with some embodiments, relating to the term event, condition/state and trigger. For example, an event may be understood, in some context, a something that happens—e.g. a loss of service, a loss of coverage, a power failure. Compared hereto, a condition may relate to a particular state—e.g., the Signal-to-interference-plus-noise-ratio (SINR) which is below some amount, the Reference Signal Received Power (RSRP)/Reference Signal Received Quality (RSRQ)/RSSI (Received Signal Strength Indicator)/Round Trip Delay (RTD) which is below/above a predefined value and/or within a range of values or the like. A trigger may be understood, for example, as a result of a particular event occurring.

According to an embodiment the UE is configured for obtaining the configuration information based on at least one of:
as a pre-set or pre-configured information, e.g. by default, factory settings, recently updated,
based on a past or last used, present or future mode of operation or a change in the mode of operation, e.g. from Uu to sidelink, from sidelink to Uu, from Uu to NTN, from NTN to Uu, from SL to NTN or from NTN to SL,
as information provided by the wireless communication system or network
as information provided by a database, e.g. connected to the RAN as an entity,
as information provided via an alternative radio access network, RAN, e.g. Wi-Fi, Bluetooth or the like,
as information provided by a remote UE and/or a group leader UE.

According to an embodiment the UE is configured for obtaining the configuration information as one of a plurality of configuration information.

According to an embodiment the UE is configured for receiving at least one of the plurality of configuration information by receiving and processing a wireless signal.

According to an embodiment the UE is configured for obtaining a first configuration information that causes the control unit to control the UE into an operation mode supported by a wireless communication system controller, such as a gNB, e.g., via a radio resource control, RRC, message, and the UE is configured for obtaining a second configuration information that causes the control unit to control the UE into one of different behaviors within the operation mode.

According to an embodiment the UE is configured for receiving at least a part of the first configuration information by receiving a radio resource control, RRC, message, wherein the UE is configured for obtaining at least a part of the second configuration information by receiving a transmission control information, TCI.

According to an embodiment the configuration information is a first configuration information, wherein the control unit is configured for generating the first configuration information and/or for generating a second configuration information indicating a change of an availability of a resource of the wireless communication system for a different UE of the wireless communication system, wherein the UE is configured for providing the first configuration information and/or the second first configuration information to the wireless communication system and/or the different UE.

According to an embodiment a UE configured for operating in a wireless communication system comprises a control unit configured for processing configuration information indicating a change in an availability of the resource, wherein the control unit is configured for reacting on the change of the availability by performing by at least one of a measurement, a logging, a reporting, an acknowledging, and combinations thereof related to the availability, and for providing a result thereof to the wireless communications system.

According to an embodiment a UE configured for a communication in a wireless communication system comprises: a control unit configured for generating configuration information indicating a change of an availability of a resource of the wireless communication system for a different UE of the wireless communication system, wherein the UE is configured for providing the configuration information to the wireless communication system and/or the different UE.

According to an embodiment the UE is a user equipment, UE configured for wirelessly providing the configuration information using a wireless interface of the UE.

According to an embodiment the UE is a base station, gNB, configured for wirelessly providing the configuration information using a wireless interface of the UE.

According to an embodiment the configuration information is a first configuration information and wherein the resource is a first resource, wherein the UE is configured for a communication in the wireless communication system according to a configuration using a same or different second resource of the wireless communication system and for using a wireless interface of the UE for the communication, wherein the control unit is configured for processing second configuration information indicating a change of an availability of the second resource, wherein the control unit is configured for adapting the configuration based on the second configuration information to react on the change of the availability.

According to an embodiment a wireless communication system is provided, providing wireless communication between different entities of the wireless communication system according to a configuration, the communication using a resource of the wireless communication system, the wireless communication system comprising a first entity such as a UE, gNB, database or data storage being configured for providing, to at least one member of the wireless communication system, configuration information indicating a change of an availability of a resource of the wireless communication system, and a second entity that is configured for adapting the configuration based on the configuration information to mitigate an effect of the change of the availability on at least one entity of the wireless communication system.

According to an embodiment the first entity is a UE according to an embodiment described herein, in particular a UE to use configuration information, and/or the second entity is a UE according to an embodiment, in particular a UE to provide configuration information.

According to an embodiment a method for operating a UE configured for a communication in a wireless communication system according to a configuration using a resource of the wireless communication system and for using a wireless interface of the UE for the communication comprises processing, with a control unit of the UE, configuration information indicating a change of an availability of the resource, adapting the configuration based on the configuration information to react on the change of the availability.

According to an embodiment a method for operating a UE configured for operating in a wireless communication system comprises processing, using a control unit of the UE, configuration information indicating a change in an availability of the resource, reacting on the change of the availability by performing by at least one of a measurement, a logging, a reporting, an acknowledging, and combinations thereof related to the availability, and providing a result thereof to the wireless communications system.

According to an embodiment a method for operating a UE configured for a communication in a wireless communication system comprises generating configuration information indicating a change of an availability of a resource of the wireless communication system for a different UE of the wireless communication system using a control unit of the UE, and providing the configuration information to the wireless communication system and/or the different UE.

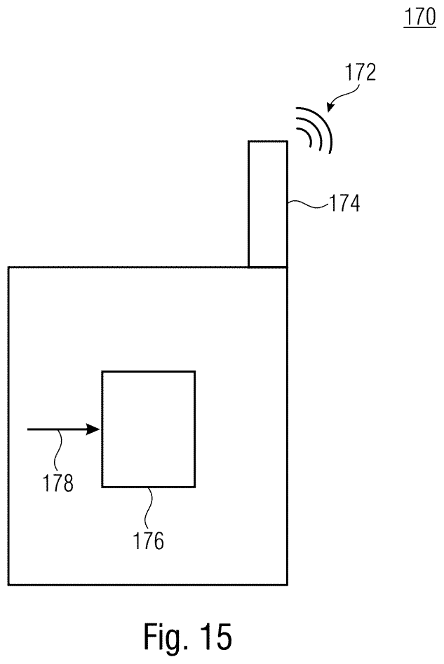

FIG. 15 shows a schematic block diagram of a UE 170 according to an embodiment. The UE 170 is configured for a communication in a wireless communication system, e.g., by transmitting and/or receiving a wireless signal 172. The UE 170 may comprise a wireless interface 174, e.g., having one or more antenna elements that are grouped into one or more antenna panels or antenna arrays. Optionally but not necessarily, the UE 170 may be configured for implementing a beam forming technique, e.g., transmitting wireless signal 172 into a first direction with a higher transmission power when compared to a different direction and/or receiving a wireless signal from a first direction with a higher sensitivity when compared to a different direction.

According to an implementation that may be realized in addition to the features described for UE 170 or that may provide for an alternative implementation of the UE 170, the UE 170 is configured for operating in a wireless communication system and comprises the control unit 176 configured for processing the configuration information 1718 indicating a change in an availability of the resource used for communication. The control unit 176 is configured for reacting on the change of the availability by performing by at least one of a measurement, a logging, a reporting, an acknowledging, and combinations thereof related to the availability, and for providing a result thereof to the wireless communications system. That is, the change may lead to a reaction comprising a measurement, logging, reporting and/or acknowledging.

The communication in the wireless communication system may be organized according to a configuration that instructs a use of a resource of the wireless communication system. A configuration may include or relate to at least one of a transmission, a reception, or combinations thereof provided by the UE as the communication. Alternatively or in addition, the configuration may relate to a measurement, a logging, a reporting, an acknowledging and/or combinations thereof to be provided by the UE. Alternatively or in addition, the configuration may relate to a transmission and/or a reception of at least one preconfigured signal, e.g., a test signal, of at least one preconfigured reference signal and/or of at least one preconfigured message such as a test message. Alternatively or in addition, the configuration may relate to a performing of a procedure of transmission of at least one signal and/or a procedure of reception of at least one signal and processing thereof, e.g., beam sweeping, performing a frequency sweep or the like. For example, the configuration may indicate, describe or instruct a behavior of the UE on how to perform its communication. For communication, a resource of the wireless communication system that is used may relate to a time resource, a frequency resource, a code resource but is not limited hereto. For example, a resource may not only relate to a resource element in the time-frequency grid but may also relate to a coverage, a service to be used or provided and/or other usable parts of a wireless communication system, amongst them:
an access link resource, a sidelink resource, a relay link resource and/or a backhaul link resource,
a temporal, spectral, sequential (spreading sequence) and/or spatial communication resource,
a transport channel, a positioning channel, a control channel and/or a data channel,
a transmission/reception beam represented by a beam-ID, SSB, CSI-RS, a beam sweep and/or a coordinated beam constellation,
a propagation channel component such as a line-of-sight, LOS, non-line-of-sight, NLOS, obstructed line-of-sight, OLOS, a dominant or specific multi-path component, MPC,
a service or connectivity provided by another network entity such as a gNB, a core network, an access network, a repeater, a reconfigurable intelligent surface, RIS, or a satellite,
a quality of service, QoS, related to communication metrics such as coverage, capacity, latency and/or jitter.

The UE 170 comprises a control unit 176, e.g., an adapted implementation of a processor 202 or a different processing unit. The control unit 176 is configured for processing configuration information 1718 that indicates a change of an availability of the resource. The control unit 176 is configured for adapting the configuration based on the configuration information to react on the change of the availability. The change may presently occur or may be an event to occur in future. However, this does not preclude to changing an event in the past.

By processing the configuration information, a possibly unexpected change in the availability of the resource becomes known and/or expected for the UE 170 such that it can adapt its behavior, i.e., configuration. Embodiments of the present invention go beyond a rejection or acknowledgement of a grant of resources or a schedule of further communication. Such an adaptation of a grant of resources is considered to be a straightforward solution that is not unexpected for a UE as it has knowledge about how to behave in a positive or negative response to a request. Embodiments provide for a solution, for example, on how to react in case of an availability or unavailability, e.g., a sudden unavailability of a link or other resources.

For example, the UE 170 being implemented as a user equipment may be configured for adapting the configuration to change its behavior in the wireless communication system based on the change of the availability of the resource. For example, if communication is directed to or relayed via a UE that is only discontinuously available, e.g., as being during sometimes out-of-sight and during other times in-range or providing a line-of-sight path, by use of the configuration information, the UE 170 may become aware of those circumstances and may, for example, accumulate information to be transmitted to such entity until it again becomes available to thereby avoid, at least in parts, unnecessary transmissions. On the other hand, requests for re-transmissions or the like may be avoided as UE 170 may be aware of the fact that although reception is expected, the other entity was unable to transmit and that a request for retransmission is possibly of low benefit or even useless. Embodiments of the present invention in particular relate to an anomalous availability of the resource and/or a significant change of the availability. According to embodiments, the configuration information may lead the anomalous change of the availability to be an expected situation for the UE. For example, the anomalous availability may relate to at least of:
a time, e.g., being or indicating a start, an end, a period, an interval, a duration and/or a change of state or change of trend and/or related to at least one of:
   an availability and/or non-availability of the resource,
   an occurrence of a blockage event blocking at least a part of the communication,
   an occurrence of an outage event and/or an outage period of the communication,
   an occurrence of an interference event and/or a jamming event influencing the communication,
   an occurrence of an energy related state and/or a power related state of the communication, Examples include a low battery state, a recharging time, an estimated remaining energy, one or more transmit power constraints due to EIRP restrictions, multi-band operation and/or interference constraints,
a Resources are subject to
   a decrease below a threshold of at least one parameter relevant for the communication,
   an increase above a threshold of at least one parameter relevant for the communication,
   a maintain within or outside a corridor of values of at least one parameter relevant for the communication,
   maintain within or outside a region or area of validity of at least one parameter relevant for the communication with respect to a metric, examples may include a coverage, a capacity, a data rate, a reliability and/or a latency,
   a particular distribution of a parameter and/or states across a dimensions, e.g., a physical unit, of at least one parameter relevant for the communication using the resource, examples may include a time, a frequency, a space, a direction, a location, etc.,
a constraint related to the resource in view of at least one of:
   a provided data volume,
   an allocated spectrum and/or resource block (RB),
   a modulation and coding scheme (MCS) used for the communication,
   a block size used for the communication,
   a size of a message, a volume such as data volume or size of a folder/file or payload data and/or a number of messages, e.g., per unit time and/or unit of opportunity,
   a change of any above, e.g., a state a value and/or a trend of change such as increase→decrease, decrease→increase and/or a rate of change,
   a particular or repeated pattern, a distribution, a statistic, a state, a value and/or a trend of occurrence.

One specific but nevertheless non-limiting example of the present invention, is a UE, e.g., in a canyon and communicating with a moving satellite such that a LoS-connection to the satellite is possibly interrupted by the canyon structure leading to an anomalous degradation of the link. With the knowledge, provided through the use of configuration information, of when the connection will be interrupted and/or possibly be interrupted in future, the UE and/or the satellite may be aware of times during which the other entity is in range and may accordingly adapt their communication, amongst them: not transmitting a signal when the other entity is not reachable, avoiding re-transmissions or requests for that entity during that times and/or preparing communication for times during which communication is possible, e.g., reserving resources, collecting data to be transmitted and the like.

The configuration information may be stored or available in the UE 170 and/or may be received by use of external signaling, e.g., using a wireless signal, e.g., from a network coordinator or cell coordinator such as a base station, from another peer, e.g., using a sidelink or by use of different interfaces including wired, optical and/or wireless interfaces.

Known or state-of-the-art (SOTA) wireless communication systems are designed such that they explore the availability of communication partners, e.g., availability of a cellular network or a Wi-Fi access point, then to measure or test a propagations environment using training sequences e.g. reference symbols transmitted by at least one of the communication partners, followed by a communication access procedure, configuration/negotiation of the link and network parameters and finally use a standardized communication procedure to transfer/exchange control and user data over the wireless link.

Due to the fact that the propagation channel might change in quality or availability to support a targeted or requested quality or reliability of wireless communication, methods of link adaptation and signalling of requested or available link parameters (data rate, latency) have been introduced in many wireless systems. Such wireless systems generally rely on currently known properties of the communication channel and the assumption that within link adaptation loop control delay such properties remain. Following this rational slowly varying changes of the channel conditions can be followed and the transmission scheme adapted accordingly.

In case of fluctuations in channel properties e.g., fast fading, sporadic or localized crosslink interference a variety of mitigation and compensation schemes have be introduced, among these are diversity schemes like spreading in time or frequency, antenna diversity and packet retransmission, packet duplication or channel codes are SOTA techniques to handle statistical fluctuations in channel properties. That is, in case of an such anomalous event occurring, there is not performed an adaption of a configuration but the communication scheme is designed to tolerate such events at least to some extent.

Still, the common base of all of these known schemes is that a certain kind of minimum level of communication can be maintained.

When such a minimum level of communication is lost, the wireless communication protocol starts timers and either waits and probes if the link quality recovers or continues a predefined mode of operation to reach the other communication by e.g., k-repetitions or starting a scan for other available communication resources with the communication partner e.g., in case of a link failure on a particular transmit-receive beam pair. In the case of prearranged alternative link options, an automatic link-failure recovery procedure can be activated which allows a faster link recovery due to a priori knowledge of alternative link options and a configuration to start a link failure recovery (LFR) procedure when certain conditions are met.

In case none of the above is successful, a device operated in known systems usually concludes the non-availability of coverage or service and starts triggers to re-enter the network discovery mode. Such behaviour can be observed with any cellular phone when operated in poorly covered areas e.g. mountainous terrain. In this example, when the device has completed yet another network scan process through which the device identifies the availability of a network, a random-access procedure can be initiated. Depending on the time duration between the loss of connection and the (re-)establishment of the other link or the determination of communication related parameters e.g., session ID, end-to-end encryption might have exceeded a predefined period of non-activity and a communication session is therefore (re-)started from the beginning.

When compared to such known systems, the solution provided by the disclosed embodiments may provide means to handle communication interruptions and reduce the time needed for the (re-)establishment of communication(s), session(s) etc. significantly. This may be achieved through the use of configuration information relating to past, current and/or future occurrences of communication resource shortage/changes, so far not successfully covered by the above explained SOTA mechanisms. This also includes solutions to collect respective information allowing to generate such configuration information.

In order to address the problem described in connection with known systems, embodiments provide a technical solution to address the drawbacks, in particular in connection with a loss of communication but not limited hereto.

For example, when considering a wireless communication system, WCS, comprised of at least one but advantageously at least two UEs and with reference to the scenario described in connection with known systems, three scenarios may be identified:

| Scenario | Tag line | Description |
|---|---|---|
| A | Both UEs (still) in | the UEs are both (still) “in coverage” and “in service” of |
| | | the RAN. |
| B | Remote UE out | a first UE is “in coverage” but “out of service” and a |
| | | second UE is both “in coverage” and “in service” |
| C | Both UEs out | Both a first and a second UE are “out of coverage” and |
| | | “out of service”. |

With reference to Scenarios A, B and C, Scenario A depicts a WCS use case in which the at least two UEs are both IC and IS of the RAN. This could be considered to be an ideal situation or a reference situation since during this mode of operation, configuration information pertaining to communication resources is readily available not only for the present conditions but perhaps also for anticipated, expected or planned future conditions.

In contrast Scenario B depicts a WCS use case in which only one UE is IS even though both are IC. In a known state-of-the-art WCS, the out-of-service, OOS, UE is unaware of when, where and how communication resources will become or are expected to become available in the future. The OOS UE might therefore use its own resources in an unnecessary and/or ineffective manner. This could have the effect of at least reducing its battery capacity or creating interference to other users.

In Scenario C, in which both UEs are both OOC and OOS, the negative consequences of Scenario are exasperated even further which could result in even greater levels of interference and a degradation of service quality for other users.

The technical solution provided by embodiments attempts to alleviate the deleterious effects described in Scenarios B and C referred to as anomalous changes of an availability of a resource by ensuring that the UEs are provided with configuration information using one or more of the following methods or sources of information:
Pre-set or preconfigured (e.g. by default, factory settings, recently updated), e.g., stored in an internal or external memory.
Based on a former, e.g., the last used mode of operation or the mode of operation or a change in the mode of operation (e.g. from Uu to sidelink, from sidelink to Uu, from Uu to NTN, from NTN to Uu, from SL to NTN or from NTN to SL).
Provided by the network/WCS, e.g., via a wireless or wired signal or message.
Provided by a database (e.g. connected to the RAN as an entity), the information provided directly or indirectly (via a different entity) via a wireless or wired signal or message.
Provided via an alternative RAN (e.g. Wi-Fi, Bluetooth).
Provided by a remote UE or a group leader UE or a different network entity.

For example, the configuration information may be provided in the form of an Assisting Information Message AIM, wherein the one or more AIMs may include one or more of the following:
resource allocation related assistance information, like
   resource patters,
   resource pools,
   available and/or excluded radio resources,
   information about particular frame structures, e.g., (pseudo)-TDD slot structures on FDD bands, sub-band full duplex, SBFD, configurations, almost blank subframes, ABS, in one or more FDD or TDD bands to be used for SL-communication,
   a sub-band full duplex, SBFB, configuration indication,
link related assistance information, like
   temporal (current and future), availability/unavailability, readiness of connectivity opportunities (e.g. windows of opportunity to see a satellite or satellite constellation areas), shortage or plentifulness of resources,
timing advance assistance information,
Doppler assistance information,
distance related assistance information,
geographical area related assistance information,
group related assistance information,
UE pair related assistance information,
relay/repeater related assistance information,
capability information of a device transmitting or receiving the AIM,
requested information by the device transmitting or receiving the AIM about capability information to be provided by the UE,
a distress message header with wakeup, configuration state activation trigger function or priority purpose (e.g. transmitting an emergency message containing distress ID, requested action, location, UE-ID etc.).

The described three scenarios A, B and C above can be considered as example connectivity states of two UEs within the same coverage area and advantageously connected to the same RAN network e.g. via a satellite access link or a concatenated satellite backhaul link (scenario A).

While devices or entities (e.g. UEs) may be connected to the network via a gNB, their configuration and therefore their behaviour can be configured and controlled within the configuration framework.

Configuration in this context can be understood on different levels. For example, on a first level wherein the device is configured to support a particular feature to respond to signals/messages it will receive later, and on a second level wherein the device is configured in particular states which are valid within a framework of a feature. Examples for such configurations are not limited to include:
1^{st} level configuration: for example, a configuration of a device into a mode supported by a gNB/network. This may be done via RRC messaging and is therefore usually of larger message size and is relatively slow.
2^{nd} level configuration: for example, a configuration of relationships between reference symbols (RS), channels etc. via the transmission control information (TCI) which is using a highly compressed self-referencing messaging space.

According to embodiments a single level of configuration, two levels of configurations or even a higher number of levels may be used to cause the UE to adapt its configuration, e.g., at least three, at least four, at least five, at least ten or even more. Different levels of the plurality of configuration information may comprise a different granularity or accuracy with regard to one or more parameters or a sequence of them. As an alternative or in addition, different levels of the plurality of configuration information may comprise different levels of priority, i.e., a configuration information of higher priority may lead to an adjustment or to discard or drop configuration information, at least for a same parameter, action or behaviour, available at a lower priority. However, as a further alternative or even in addition, an different levels of configuration information may be obtained, received or processed from different sources. Different sources may be understood, for example, as being received or retrieved from a same entity at different instances of times, e.g., by receiving different signals. This does not preclude to obtain, e.g., a first level of configuration information without receiving a signal, e.g., from an internal memory and a second level of configuration information, e.g., of higher priority, from a different source, e.g., by receiving a wireless signal. As long as the second level of configuration is unavailable, the UE might still rely on the possibly pre-configured first level of configuration information.

For example, when a device/UE loses connectivity to the gNB/CU/access network or other network elements (e.g. other devices or the core network) connectivity to other devices can be maintained such that the further connectivity can be used to obtain configuration information from or via the device belonging to the remaining connection.

In the context of some embodiments related to this invention, the configuration information (CI) may consist of or may comprise information about and/or is associated with transmission/reception configurations relating to a particular kind of shortage of communication resources, in particular an anomalous shortage the CI can be communicated/provided via any available/remaining communication link.

The CI may refer to scarce/reduced or abundant/plentiful/sufficient resources and their past, current and future availability/non-availability.

Configuration may refer to one or more of:
Transmission, reception, and combinations thereof, e.g., provided by the UE as part of the communication
Measuring/logging/reporting/acknowledging, and combinations thereof provided by the UE
Transmission, reception of preconfigured (test or reference) signals/messages
Performing a procedure of transmission, reception of signals and processing thereof e.g., beam sweeping, frequency sweep,

Resources referred to in connection with embodiments may comprise one or more of:
Access link, sidelink or backhaul link resources.
Temporal, spectral, spatial communication resources.
Transport, positioning, control or data channels.
Transmission beams (beam-IDs, beam sweeps, coordinated beam constellations)
Propagation channel components e.g., line-of-sight (LOS), non-line-of-sight (NLOS), obstructed line-of-sight (OLOS), dominant or specific multi-path components (MPC).
Service/connectivity provided by gNB, core network, access network, repeater, RIS, satellite.
Quality of service (QOS) related to metrics like coverage, capacity, latency, jitter.

An indication of availability of such a resource may refer to at least one of:
Time being a start, end, period/interval/duration or change of:
   Availability or non-availability of resources.
   Occurrence of blockage event.
   Occurrence of outage events or periods.
   Occurrence of interference or jamming events.
   Occurrence of energy or power related states e.g., low battery state, recharging time, estimated remaining energy, transmit power constraints due to EIRP restrictions, multi-band operation, interference constraints.
   Resources may be subject to
      decrease of a parameter below a threshold,
      increase of a parameter above a threshold,
         maintain a parameter within or outside a corridor of values,
      maintain a parameter within or outside a region or area of validity with respect to a metric e.g., coverage, capacity, data rate, reliability, latency,
      a particular distribution across the dimensions of resources in e.g., time, frequency, space, directions, location, etc.
   Resources may be constrained by:
      Data volume.
      Allocated spectrum, resource blocks (RB).
      Modulation and coding scheme (MCS).
      Block size.
      Message size/message volume/number of messages (per unit time or unit of opportunity).
   Availability may relate, e.g., to a change of any above states/values or trends (increase→decrease, decrease→increase).
   Availability may relate, e.g., to a particular or repeated patterns of occurrence, distribution, statistic, states, values or trends.

Said examples of the availability advantageously match the respective resource. That is, for example, an availability of an access link may more relate to an availability or blockage event whilst a resource QoS may more relate to a block size or MCS when compared to the allocated spectrum, not precluding such an association.

As an alternative or in addition, the configuration information may further contain at least one of:
a trigger,
an event,
a condition,
a combination or sequence of any of the above (including combinations of several triggers, events, conditions), e.g., indicating one or more of a:
   state,
   status,
   period,
   event,
   request,
   report,
   action,
   procedure, to:
      start/pause/continue/end,
      activate/deactivate,
      confirm/acknowledge.

Among actions/procedures requested or activated by e.g. a trigger or event are:
starting/stopping/resetting/halting of counters or count-down timers,
capturing, freezing, storing, forwarding current and future (anticipated) states and configurations,
automatic (re)-configuration after a trigger/event occurred, or condition is met,
starting/halting/delaying/restarting/preparing to start a procedure or mode of operation,
changing from one procedure, routine or mode of operation into another one,
determining or selecting a mode of operation, a transmission/reception strategy,
discovering/observing/detecting/monitoring/tracing events or parameters related to any of the above CI and associated actions, triggers, configuration variants thereof (example: UE is observing pattern of availability of one or more beams based on RS or beam-ID and determining or reporting future availability, based on this another device e.g., a gNB or RIS can be configured to go/remain in particular configuration states such that a certain coverage/capacity requirement of a particular UE is fulfilled),
prepare reports/messages/control or user data transmissions/receptions to be ready to be transmitted/received at one of the next/future connection availability events.

Embodiments described above relate to a UE that adapts its configuration based on configuration information. Embodiments also relate to obtaining, collecting and/or providing such configuration information.

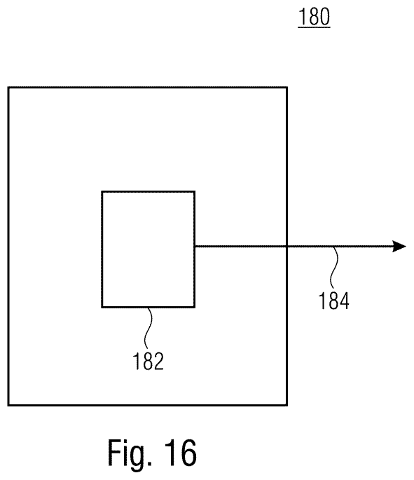

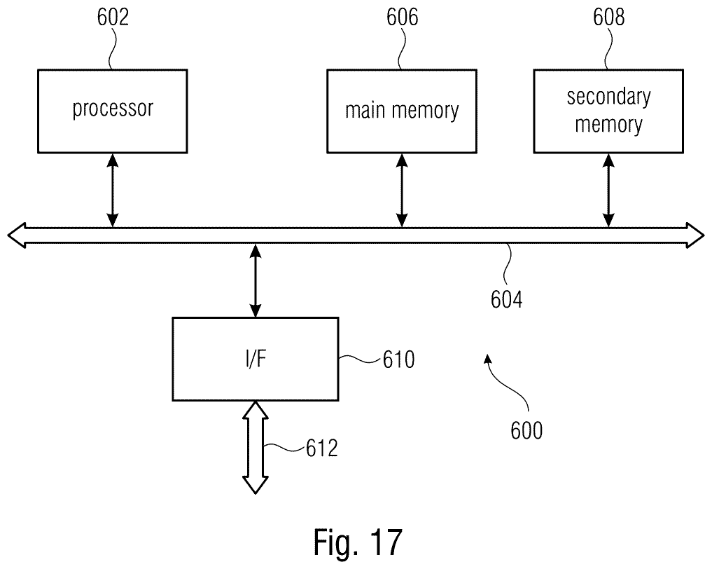

FIG. 16 shows a schematic block diagram of a UE 180 according to an embodiment. The UE 180 is configured for a communication in a wireless communication system. The UE 180 comprises a control unit 182 that is configured for generating configuration information 184 indicating a change of an availability of a resource of the wireless communication system for a different network entity of the wireless communication system. The configuration information 184 may comprise at least a part of the configuration information 1718 and/or may comprise different configuration information described herein. The UE 180 is configured for providing the configuration information 184 to the wireless communication system and/or the different network entity. It may, according to an embodiment, use the configuration information for an own purpose as described in connection with UE 170.

However, when compared to the UE 170, the UE 180 providing the configuration information is not necessarily required to communicate in the WCS by use of the RAN and/or the communication scheme. The UE 180, may, for example, operate as a sensor or other measurement and/or logging device providing respective data or information, e.g., based on its configuration and/or upon request. The configuration information 184 may be provided to other devices by use of a wired, optical and/or wireless (radio) interface and a respective signal. For example, providing the configuration information 184 to a memory using a wired signal, the memory accessible to the UE 170 via a RAN may allow to implement the UE 180 without a wireless interface such as wireless interface 174.

In accordance with further embodiments, the above-mentioned assistance information messages, AIMs, may include one or more of the following:
resource allocation related assistance information, like
   resource patters
   resource pools
   available and/or excluded radio resources
   information about particular frame structures, e.g., (pseudo)-TDD slot structures on FDD bands, sub-band full duplex, SBFD, configurations, almost blank subframes, ABS, in one or more FDD or TDD bands to be used for SL-communication
   a sub-band full duplex, SBFB, configuration indication
link related assistance information, like
   temporal (current and future), availability/unavailability, readiness of connectivity opportunities (e.g. windows of opportunity to see a satellite or satellite constellation areas), shortage or plentifulness of resources
timing advance assistance information
Doppler assistance information
distance related assistance information,
geographical area related assistance information,
group related assistance information,
UE pair related assistance information,
relay/repeater related assistance information,
capability information of a device transmitting or receiving the AIM,
requested information by the device transmitting or receiving the AIM about capability information to be provided by the UE,
a distress message header with wakeup, configuration state activation trigger function or priority purpose (e.g. transmitting an emergency message containing distress ID, requested action, location, UE-ID etc.).

In accordance with further embodiments, the above-mentioned configuration information and/or AIMs may be provided to the UE via the SL-BC response provided by the network entity as described above in the embodiment of FIG. 5.

### General

Although the respective aspects and embodiments of the inventive approach have been described separately, it is noted that each of the aspects/embodiments may be implemented independent from the other, or some or all of the aspects/embodiments may be combined.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a RAN network entity, like the gNB, comprises one or more of the following: a macro cell base station, or a small cell base station, or a central unit of a base station, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 16 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A wireless communication network, comprising:
one or more relay devices, wherein a relay devices provides a first bidirectional link comprising first relay resources, and a second bidirectional link comprising second relay resources, the first and second bidirectional links using a first interface for a communication with a radio access network, RAN, of the wireless communication network, e.g., the Uu interface, and
one or more user devices, UEs, wherein a UE is to perform a direct communication with a network entity of the wireless communication network via the relay device on one or more the first relay resources or on one more of the first and second relay resources using a second interface for a device-to-device, D2D, or sidelink, SL, communication in the wireless communication network, e.g., the PC5 interface.

2. The wireless communication network of claim 1, wherein
the network entity comprises a RAN entity, like a base station,
the UE is to perform a communication with the relay device on the first relay resources using the second interface, and
the relay device is to perform a communication with the RAN entity on the second relay resources using the first or second interface.

3. The wireless communication network of claim 2, wherein the UE is to perform the communication with the relay device on the first relay resources using the second interface responsive to one or more of the following:
a loss of connection between the UE and the RAN,
a connection between the UE and the RAN cannot be established,
a connection via the RAN cannot provide one or more required communication requirements, such as a desired Quality of Service, QoS, e.g., a latency, a bandwidth or capacity or data rate of a backhaul connection, or an end-to-end reliability may be not sufficient for obtaining the desired QoS,
a signaling indicting one or more operational modes related to a different use of the first and/or second resources and the first interface compared to a currently or previously used operational mode.

4. The wireless communication network of claim 1, wherein
the a network entity comprises a further UE,
the UE is to perform a communication with the relay device on the first relay resources using the second interface, and
the relay device is to perform a communication with the further UE on the second relay resources the first or second interface.

5. The wireless communication network of claim 4, comprising
a RAN entity, like a base station, and
a further relay device providing a third bidirectional link between the further UE and the further relay station and comprising third relay resources, and a fourth bidirectional link between the further relay station and the RAN entity and comprising fourth relay resources, the third and fourth bidirectional links using the first interface,
wherein
the further UE is to perform a communication with the further relay device on the third relay resources using the first or second interface, and
the further relay device is to perform a communication with the RAN entity on the fourth relay resources using the first or second interface.

6. The wireless communication network of claim 4, wherein the UE is to perform the communication with the further UE on the first and second relay resources using the first second interface responsive to one or more of the following:
a loss of connection between the UE and the RAN,
a connection between the UE and the RAN cannot be established,
a connection via the RAN cannot provide one or more required communication requirements, such as a desired Quality of Service, QoS, e.g., a latency, a bandwidth or capacity or data rate of a backhaul connection, or an end-to-end reliability may be not sufficient for obtaining the desired QoS,
a loss of connection between the relay device and the RAN,
a connection between the relay device and the RAN cannot be established,
a connection via the relay device cannot provide one or more required communication requirements, such as a desired Quality of Service, QoS, e.g., a latency, a bandwidth or capacity or data rate of a backhaul connection, or an end-to-end reliability may be not sufficient for obtaining the desired QoS,
a loss of sidelink connection between the UE and the further UE, the sidelink connection being performed on sidelink resources of the wireless communication network, the sidelink resources being different from the first and second relay resources,
a connection sidelink between the UE and the further UE cannot be established,
a sidelink between the UE and the further UE cannot provide one or more required communication requirements, such as a desired Quality of Service, QoS, e.g., a latency, a bandwidth or capacity or data rate of a backhaul connection, or an end-to-end reliability may be not sufficient for obtaining the desired QoS,
a signaling indicting one or more operational modes related to a different use of the first and/or second resources and the first interface compared to a currently or previously used operational mode.

7. The wireless communication network of claim 1, comprising a base station serving the UE and providing for an indirect communication between the UE and the network entity via the relay device, wherein, if a connection between the UE and the network entity is established, the UE is to
perform only the direct communication with the network entity, or
perform the direct communication with the network entity in addition to the indirect communication with the network entity.

8. The wireless communication network of claim 1, wherein the UE is aware of an availability or an expected availability of the relay device, and is to send a messaging information via an uplink sidelink broadcast, SL-BC, to the relay device on the first relay resources.

9. The wireless communication network of claim 8, wherein, responsive to receiving the uplink SL-BC, the relay device is to forward the messaging information received in the uplink SL-BC towards at least the network entity via a downlink SL-BC.

10. The wireless communication network of claim 9, wherein, responsive to receiving the downlink SL-BC, the network entity is to send a response message to the UE.

11. The wireless communication network of claim 10, wherein
the network entity is to send the response via a further uplink sidelink broadcast, SL-BC, to the relay device on the first or second relay resources,
responsive to receiving the further uplink SL-BC, the relay device is to forward the response message received in the further uplink SL-BC towards to the UE entity via a further downlink SL-BC on the first relay resources.

12. The wireless communication network of claim 1, comprising a remote UE, wherein the UE and the remote UE are directly connected with each other, and the UE is to relay a communication between the remote UE and the network entity.

13. The wireless communication network of claim 12, wherein the UE has a plurality of RAT capabilities, the plurality of RAT capabilities comprising
a first RAT capability for providing a SL connection with the remote UE using sidelink resources of the wireless communication network, the sidelink resources being different from the first and second relay resources, and the UE is to relay a communication to/from the remote UE, and
a second RAT capability for connecting the remote UE and the UE, e.g., Wi-Fi or Bluetooth.

14. The wireless communication network of claim 12, wherein the UE is subscribed, in addition to the wireless communication network, to one or more further networks, and wherein the UE and the remote UE are connected via
the wireless communication network providing a SL connection between the UE and the remote UE using sidelink resources of the wireless communication network, the sidelink resources being different from the first and second relay resources, and the UE is to relay a communication to/from the remote UE, and/or
one or more of the further networks, e.g., Wi-Fi or Bluetooth.

15-16. (canceled)

17. The wireless communication network of claim 1, wherein the first and second relay resources to be used by the UE for communicating with the network entity comprise unused or substantially unused radio resources allocated for a communication using the first interface.

18-19. (canceled)

20. The wireless communication network of claim 1, wherein the first relay resources and/or second relay resources are allocated according to a FDD configuration paired spectrum, the FDD configuration paired spectrum defining a first or downlink, DL, frequency band for transmissions by the relay device and a second or uplink, UL, frequency band to transmissions to the relay device.

21-23. (canceled)

24. The wireless communication network of claim 1, wherein the UE is to obtain a configuration for performing the communication with the network entity using one or more of the following:
a pre-set or preconfigured configuration, e.g., a default configuration, a configuration according to factory settings, a recently updated configuration,
based on a last used configuration or a last used mode of operation or a change in a mode of operation, e.g. from a Uu link to a sidelink, from a sidelink to a Uu link, from a Uu link to a relay link, from a relay link to a Uu link, from a SL to a relay link or from a relay link to a SL),
a configuration provided by the network,
a configuration provided by a database, e.g., a database connected to the RAN as an entity,
a configuration provided via an alternative RAN, e.g., via Wi-Fi or Bluetooth,
a configuration provided by a remote UE or a group leader UE,
a configuration provided by a sidelink connection either:
directly from a further UE connected over the SL with the UE, or
indirectly from a further UE connected over the SL and via the relay device with the UE.

25. The wireless communication network of claim 1, wherein the UE is to receive from the network entity one or more assistance information messages, AIMs,
wherein the one or more AIMs may include one or more of the following:
resource allocation related assistance information, like
resource patters
resource pools
available and/or excluded radio resources
information about particular frame structures, e.g., (pseudo)-TDD slot structures on FDD bands, sub-band full duplex, SBFD, configurations, almost blank subframes, ABS, in one or more FDD or TDD bands to be used for SL-communication
a sub-band full duplex, SBFB, configuration indication
link related assistance information, like
temporal (current and future), availability/unavailability, readiness of connectivity opportunities (e.g. windows of opportunity to see a satellite or satellite constellation areas), shortage or plentifulness of resources timing advance assistance information
Doppler assistance information
distance related assistance information,
geographical area related assistance information,
group related assistance information,
UE pair related assistance information,
relay/repeater related assistance information,
capability information of a device transmitting or receiving the AIM,
requested information by the device transmitting or receiving the AIM about capability information to be provided by the UE,
a distress message header with wakeup, configuration state activation trigger function or priority purpose (e.g. transmitting an emergency message containing distress ID, requested action, location, UE-ID etc.).

26-30. (canceled)

31. The wireless communication network of claim 1, wherein the UE and/or the relay device are to signal capability information.

32-35. (canceled)

36. A method for operating a wireless communication network, comprising one or more relay devices, wherein a relay devices provides a first bidirectional link comprising first relay resources, and a second bidirectional link comprising second relay resources, the first and second bidirectional links using a first interface for a communication with a radio access network, RAN, of the wireless communication network, e.g., the Uu interface, the method comprising:
performing by one or more user devices, UEs, a direct communication with a network entity of the wireless communication network via the relay device on one or more the first relay resources or on one more of the first and second relay resources using a second interface for a device-to-device, D2D, or sidelink, SL, communication in the wireless communication network, e.g., the PC5 interface.

37. (canceled)
